(19) United States
(12) Patent Application Publication
(10) Pub. No.: US 2004/0031019 A1
(43) Pub. Date: Feb. 12, 2004

(54) Debugger for a graphical programming environment

(76) Inventors: Richard Lamanna, Barrington, RI (US); Christopher J. Phillips, Walpole, MA (US)

Correspondence Address: CESARI AND MCKENNA, LLP, 88 BLACK FALCON AVENUE, BOSTON, MA, 02210, US

(21) Appl. No.: 10/441,463

(22) Filed: May 20, 2003

Related U.S. Application Data
(60) Provisional application No. 60/381,979, filed on May 20, 2002.

(51) Int. Cl. G06F 9/44

(52) U.S. Cl. 717/125; 717/129

(57) ABSTRACT

A debugger utility allows a graphically or visually created application program to be run in a debug mode. The graphically created program includes a block diagram that, in turn, has plurality of icons. The icons have pins thereby allowing the icons to be interconnected by one or more wire constructs. Using the debugger utility, the developer can insert a break point on any icon, pin or wire construct, preferably through graphical inputs. During execution, the debugger utility automatically pauses the application program when the inserted break points are reached. The debugger utility also changes the appearance of the block diagram during execution in debug mode to illustrate the program's execution sequence. One or more tools are provided that permit the developer to examine the state of the application program, including variable values, while it is being executed in debug mode.

### CROSS-REFERENCE TO RELATED APPLICATIONS

The present application claims the benefit of U.S. Provisional Patent Application Serial No. 60/381,979, which was filed on May 20, 2002, by Richard Lamanna and Christopher Philips for a Debugger for a Graphical Programming Environment and is hereby incorporated by reference.

The present application is related to the following U.S. patent applications:

U.S. patent application Ser. No. 09/483,760 entitled, METHOD AND APPARATUS FOR RESOLVING DIVERGENT PATHS IN GRAPHICAL PROGRAMMING ENVIRONMENTS, filed Jan. 14, 2000, now U.S. Pat. No. 6,425,121; and

U.S. patent application Ser. No. 09/483,122 entitled, REPEATING PROGRAM OBJECT FOR USE WITH A GRAPHICAL PROGRAM-DEVELOPMENT SYSTEM, filed Jan. 14, 2000, now U.S. Pat. No. 6,425,120, which are hereby incorporated by reference in their entireties.

### BACKGROUND OF THE INVENTION

1. Field of the Invention

The present invention relates generally to the field of computer programming and, more specifically, to software development environments.

2. Background Information

To generate a software program that can be executed or run by a computer, a software developer or programmer typically chooses a programming language, such as BASIC (Beginner's All-purpose Symbolic Instruction Code), Fortran, C, etc., and writes source code using the keywords, syntax, variable names, data structures, etc. defined by the selected programming language. Each programming language typically defines its own unique syntax and keywords for performing various functions. After the source code has been written, it is typically converted by a compiler into a machine readable format that can be understood by the computer (e.g., object code). If the developer used incorrect keywords or syntax, the source code cannot by compiled successfully.

The source code is typically written with a text editor and organized into a series of lines of code. Although simple programs may only need a few lines of code, complex programs often consume hundreds, thousands or tens of thousands of lines of code. Significant portions of code, moreover, are often required just to generate displayable user interface images or forms, such as text boxes, command buttons, etc. that can be displayed by windows-based computer systems, such as personal computers running the Microsoft Windows® series of operating systems from Microsoft Corporation of Redmond, Wash. Furthermore, significant editing is often required to make even relatively minor adjustments to such user interface elements (e.g., moving, re-sizing, etc.).

In order to simplify the creation of such user interface images or forms, Microsoft developed and released a programming system known as Visual Basic®. Visual Basic includes a language engine for executing text-based programming statements, and a forms layout package having a plurality of objects or icons representing common user interface elements, such as text boxes, radio buttons, command buttons, scroll bars, etc. When a developer selects one of these objects from a tool palette and places it onto a form window, Visual Basic automatically creates corresponding code to support that object. By eliminating the need to write code just to display conventional interface elements, Visual Basic greatly simplified the creation of programs to be run on Windows-based platforms. These objects are typically stored in one or more dynamic link libraries (DLLs) that are loaded and run as necessary at application run-time. Since Visual Basic is an “open” programming languages, meaning that its syntax and command structures are known and available, third-parties have created and marketed a whole range of objects that can be added to a Visual Basic forms window to facilitate the creation of all sorts of different application programs.

With the release of Visual Basic 4.0, Microsoft extended Visual Basic to support software constructs that have certain object-oriented features by basing this release on its Component Object Model (COM). With Visual Basic 4.0, a new type of object, often referred to as a COM or ActiveX control or object was defined. A COM or ActiveX control is basically a component program object based on Microsoft's COM technologies, which can issue or raise events. With Visual Basic 4.0 and later releases, a developer similarly uses a forms layout package to drag and drop one or more ActiveX controls onto a form window. In addition, by double-clicking an ActiveX control on the form window, a code window is displayed. Inside this code window, the developer may insert text-based programming code to handle the events raised by the respective ActiveX control (i.e., an event handler). This code must comply with the syntactical and keyword constraints defined by Visual Basic in order for it to be properly executed at application run-time. By writing these event handlers, a developer can cause various ActiveX controls to share information and otherwise interact with each other greatly facilitating the creation of application programs.

FIG. 1 illustrates a conventional Visual Basic work space 100 that may be displayed on a computer screen. The work space 100 includes a Form window 102 and a tool palette 104. The tool palette 104 contains a plurality of icons, which represent individual controls, including a vertical scroll control 106 and a text label control 108, among others. A developer may select any of the controls contained on palette 104 to cause the selected control to appear on the Form window 102. By selecting the vertical scroll icon 106, for example, a corresponding vertical scroll image 110 is displayed on the Form window 102. A text label image 112 may be placed on the Form window 102 in a similar manner. At this point, however, there is no inter-relationship between the objects corresponding to vertical scroll image 110 and text label image 112. In order to establish some such relationship (e.g., causing the text label to display the current position of the vertical scroll), the developer must write a subroutine (e.g., an event handler). Each line or statement of the subroutine, moreover, must conform to the syntax and keyword commands of the underlying programming language (e.g., Visual Basic). Specifically, the developer selects the vertical scroll 110, thereby causing a code window 114 to be displayed on screen 100. Inside the code window 114, the developer writes a text-based subroutine 116 that causes the output of the vertical scroll 110 to be displayed in the text label 112.

When this program is subsequently run, images for the vertical scroll bar 110 and the text label 112 will appear on the screen of the user as part of a user interface. The text label 112, moreover, will display the position of the vertical scroll bar 110 (e.g., “2256”). If the user moves the slider bar of the vertical scroll, the contents of text label;

change to display the scroll bar's new position (e.g., “3891”). As shown, with Visual Basic, the developer need not “write” any code to cause the vertical scroll bar image 110 or the text label image 112 to be displayed on the computer screen during run time. In addition, during the programming phase, the developer may move and re-size these user interface elements simply by manipulating their appearance on the Form window 102 (e.g., with a mouse) in a conventional manner. Due to the relative ease with which application programs having user interface elements can be created, Visual Basic has become a highly popular programming tool. However, in order to develop a meaningful application program (i.e., one in which there is some inter-relationship between the user interface elements), the developer must write, in a text-based format, one or more subroutines. Thus, the developer must learn and is limited by the syntax and keyword structures of Visual Basic.

In addition to Visual Basic and its related products (e.g., Visual C++, etc.), several companies have created software development tools that are almost entirely visually oriented. That is, using these tools, a developer can create an executable application program without having to write a single line of text-based code. For example, National Instruments Corporation of Austin, Texas has created a programming tool called Lab-VIEW™ for creating virtual instruments primarily for use in the instrumentation industry. Hewlett Packard Company of Palo Alto, Calif. has similarly created a programming tool called HP VEE for generating software programs for use in the electronic testing and data acquisition industries.

HP VEE provides a work area in which a developer can create a data flow diagram. The developer typically selects the objects for inclusion in his or her program from a pull-down menu. HP VEE provides a fixed number of these objects which have been tailored to provide functionality commonly used in the data acquisition industry. The developer may then “draw” data lines between these objects in the work area. In response to drawing these lines, HP VEE creates program steps that transfer data or other information between the respective objects. The developer must perform all of this graphically within the work area.

Debugging

To debug a program, the programmer must typically insert one or more break points into the program. The break points are inserted by typing in particular commands that cause the program to be paused when the command is reached. A need exists for a debugging capability that can be utilized by without having to know the particular break point commands.

### SUMMARY OF THE INVENTION

Briefly, the invention relates to a debugging mode for use in a graphical or visual program-development environment. Using the program-development environment, a developer graphically specifies the logical operation of an application program in two-dimensions. Specifically, the program-development environment provides a drawing window and a plurality of icons or blocks that can be selected by the developer and placed onto the drawing window. Each icon or block represents a desired functionality that the developer adds to the application program being created by placing the respective icon on the drawing window. Each of the icons or blocks, moreover, has a plurality of pins, and the program developer-environment further provides a wire drawing tool. By using the wire drawing tool, the developer can visually link together the icons in a chosen order to form a block diagram that specifies the logical operation of the application program.

The developer can then choose to have the program-development environment run the application program in debug mode. In response, the program-development environment displays the block diagram in a debugger window. When operating in debug mode, the program-development environment provides a break point insertion tool. The developer can use the break point insertion tool to specify through graphical inputs a break point on any of the pins, wires or blocks of the block diagram. In the illustrative embodiment, a visual cue is added to the block diagram to indicate the presence of a break point. The developer can then run the application program. In response, the program-development environment executes the program. As each block and wire executes its particular function, the program-development environment temporarily changes the appearance of the respective block and wire. When the execution reaches a break point specified by the developer, execution of the application program pauses. At this point, the developer can examine the state of information, such as variable values and intermediary results, at the break point as well as at any of the blocks, pins or wires of the block diagram. The developer then selects a run button to resume execution of the application program in debug mode.

### BRIEF DESCRIPTION OF THE DRAWINGS

The invention description below refers to the accompanying drawings, of which:

FIG. 1, previously discussed, is a highly schematic illustration of a conventional visual programming environment;

FIG. 2 is a computer system configured in accordance with the present invention;

FIG. 3 is a highly schematic illustration of the software components of the computer system of FIG. 2;

FIGS. 4A-4D are preferred illustrations of a graphical user interface in accordance with the present invention;

FIG. 5 is a highly schematic block diagram of a data structure for use with the present invention;

FIGS. 6A-6B and 7 are flow diagrams of preferred methods of the present invention;

FIGS. 8A and 8B are preferred illustrations of the graphical user interface including a window for receiving textual inputs;

FIGS. 9 and 10 are preferred illustrations of a graphical user interface generated by the program-development environment of the present invention; and

FIGS. 11A-I and 12A-C are preferred illustrations of a debugger window generated by the program-development environment of the present invention.

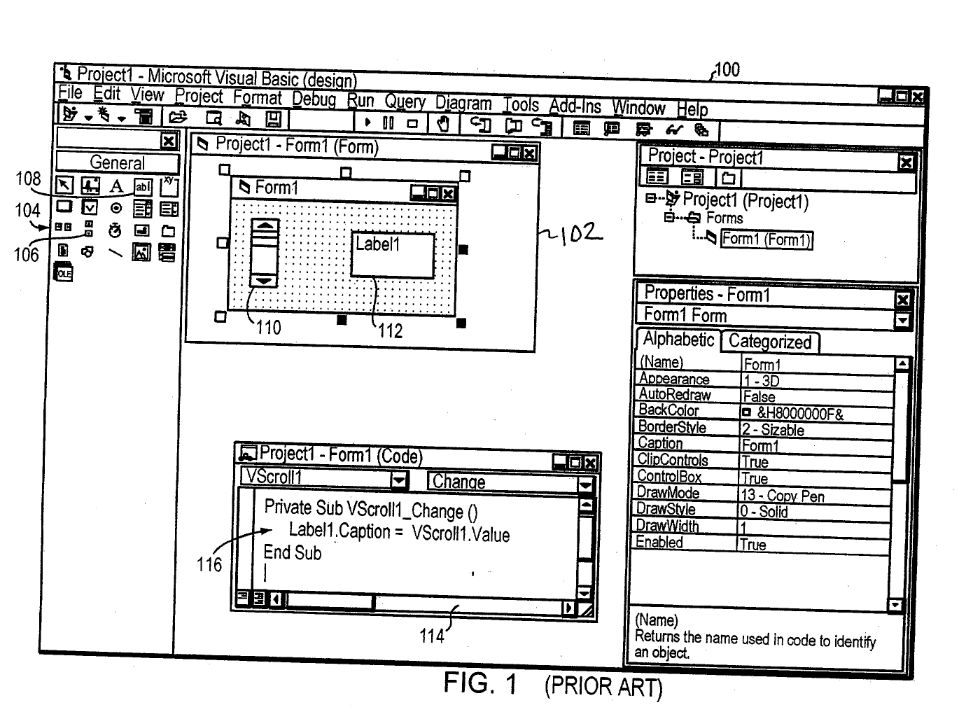

### DETAILED DESCRIPTION OF AN ILLUSTRATIVE EMBODIMENT

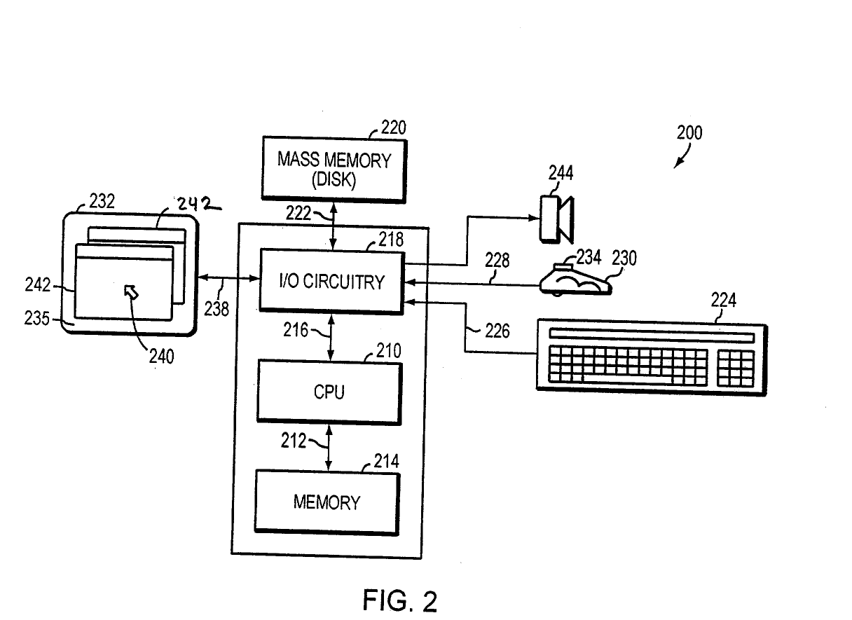

FIG. 2 illustrates a computer system 200 comprising a central processing unit (CPU) 210 coupled between a memory 214 and input/output (I/O) circuitry 218 by bi-directional buses 212 and 216, respectively. The memory 214 typically comprises random access memory (RAM) for the volatile storage of information, including application programs and an operating system, and read only memory (ROM) for persistent storage of the computer's configuration and basic operating commands. As further described is herein, the application programs and the operating system interact to control the operations of the CPU 210 and the computer system 200.

The I/O circuitry 218 may be connected to a mass memory storage unit 220, such as a disk drive, via bi-directional bus 222. In the typical system 200, the memory storage unit 220 contains instructions that can be read by the CPU 210 in order to configure system 200 to provide the program-development features of the present invention. Cursor/pointer control and input devices, such as a keyboard 224 and a mouse 230, connect to the I/O circuitry 218 via cables 226 and 228, respectively. The mouse 230 typically contains at least one button or switch 234 that may be operated by a user of the computer system 200. A monitor 232 having a display screen 235 is also connected to the I/O circuitry 218 via cable 238. A pointer or cursor 240 may be displayed on the screen 235 and its position can be controlled via the mouse 230 or the keyboard 224, as is well-known in the art. As described further herein, a window environment is displayed on the display screen 235 of the monitor 232. The window environment includes one or more windows 242. A speaker system 244 may also be connected to I/O circuitry 218.

In general, the I/O circuitry 218 receives information, such as control and data signals, from the mouse 230 and the keyboard 224, and provides that information to the CPU 210 for storage on the mass storage unit 220 or for display on the screen 235. The I/O circuitry 218 preferably contains the necessary hardware, e.g., buffers and adapters, needed to interface with the mouse 230, the keyboard 224 and the display monitor 232. The computer system 200 further includes one or more communication components, such as a Network Interface Card (NIC) or a modem (not shown), for connecting the computer system 200 to a computer network, such as the Internet.

A suitable computer system 200 for use with the present invention includes a personal computer, such as those manufactured and sold by International Business Machines Corp. of Armonk, N.Y., Compaq Computer Corp. of Houston, Tex. or Apple Computer, Inc. of Cupertino, Calif. The present invention may also be practiced in the context of other types of computers, including Unix-type workstations from Sun Microsystems, Inc. or Hewlett Packard. All of these computers have resident thereon, and are controlled and coordinated by, operating system software, such as Microsoft Windows® 95, 98 or NT, MAC OS or UNIX.

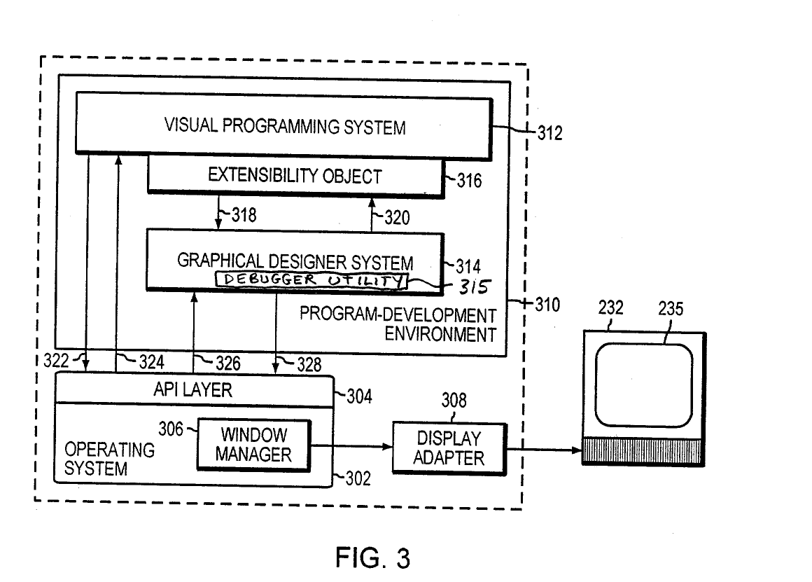

FIG. 3 is a highly schematic illustration of the software components of the computer system 200 of FIG. 2. These components include an operating system 302 having an application programming interface (API) layer 304 through which other application programs executing on computer system 200 may interact with the operating system 302. In particular, operating system 302 exchanges task commands to control the operations of the computer system 200 as well as notifications regarding various activity (e.g., windows events) with these other applications. The operating system 302 further includes system facilities, such as a window manager 306 which, inter alia, can directly implements those task commands and windows events. These system facilities are basically software routines within the operating system 302 that interoperate with lower layers of the operating system 302 and are responsible for managing various services and functions. The window manager 306, for example, may use a graphics system and a screen buffer to draw and manipulate windows on the display screen 235 of monitor 232. Under the control of various hardware and software in the computer system 200, the contents of the screen buffer may be read out and provided to a display adapter 308. The display adapter 308 contains hardware and software (sometimes in the form of firmware) which converts the information from the screen buffer to a form which can be used to drive the display screen 235 of monitor 232.

The lower-layers of the operating system 302 also include device drivers for interfacing directly with the computer hardware. For each physical device, such as the mass storage unit 220 (FIG. 2), a device driver is provided to accept requests, to read or write data or to determine the status of the devices. Communication between the physical devices and CPU 210 (FIG. 2) may be effected either through polling of the device drivers or via interrupts.

In accordance with the present invention, a program-development environment 310 is also executing on the computer system 200. The program-development environment 310 includes an extensible visual programming system 312 and a graphical designer system 314. The visual programming system 312, in turn, may include an extensibility object 316, which provides an interface for communication between the programming system 312 and the graphical designer system 314 as indicated by arrows 318 and 320. Arrow 320 represents calls from the designer system 314 to the programming system 312, while arrow 318 represents calls from the programming system 312 to the designer system 314. Additionally, both the graphical designer system 314 and the visual programming system 312 may communicate directly with the operating system 302, e.g., exchange task commands and windows events, via API layer 304, as indicated by arrows 322-328.

In accordance with the present invention, the graphical designer system 310 is further configured to include a debugger utility that can be used, as described herein, to debug application programs being created through the program-development environment.

In the illustrative embodiment, the extensible visual programming system 312 is Visual Basic 5.0 or higher (preferably 6.0) or more preferably Visual Studio .NET from Microsoft Corp., and the graphical designer system 314 is configured as a Visual Basic or Visual Studio Add-In. Nonetheless, those skilled in the art will recognize that the present invention may also be advantageously used with other extensible visual programming systems, such as Visual C++, Visual J++, Visual Cafe, Visual InterDev, Delphi (for Pascal), etc. As described in more detail below, graphical designer system 314 allows the developer to switch the program-development environment 310 seamlessly between a graphical programming paradigm and a textual paradigm. The development environment 310 generates event handler procedures or program code for incorporation into the software program being developed, in response either to textual inputs or to graphical inputs from the developer.

To utilize the program-development environment 310, the developer first opens it in a conventional manner. For example, the development environment 310 may be represented by an icon on the user's desktop, which may be opened by “clicking” the icon using mouse button 234 (FIG. 2) in a conventional manner. Alternatively or in addition, the development environment 310 may be listed as one of the available programs within a Programs folder of a Start menu or by using a Run command. The development environment 310 may be configured, upon opening, to launch the corresponding visual programming system 312 and graphical designer system 314.

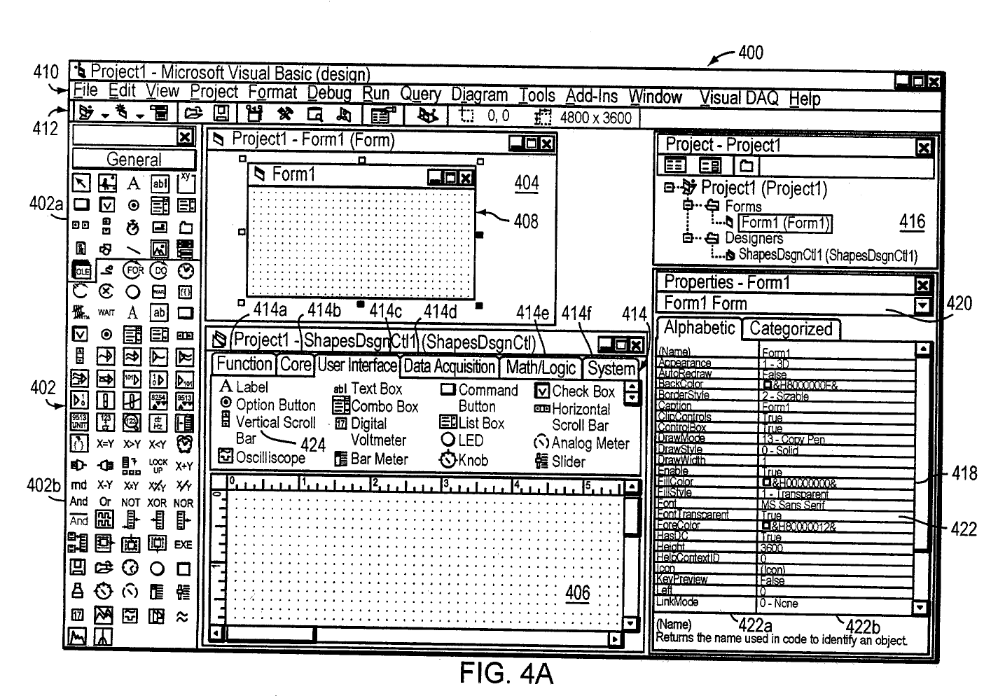

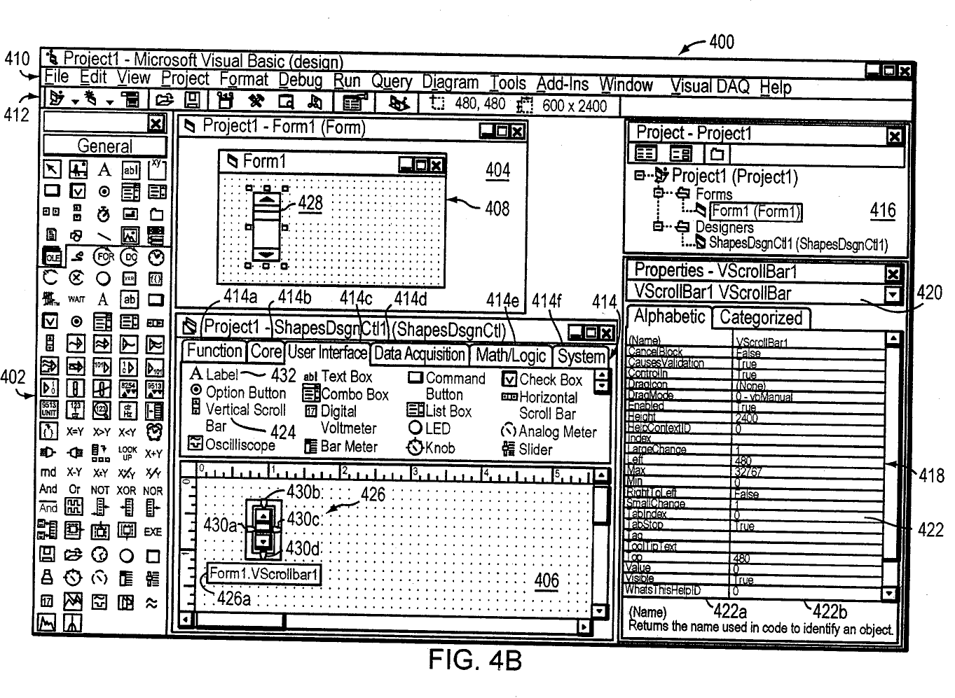

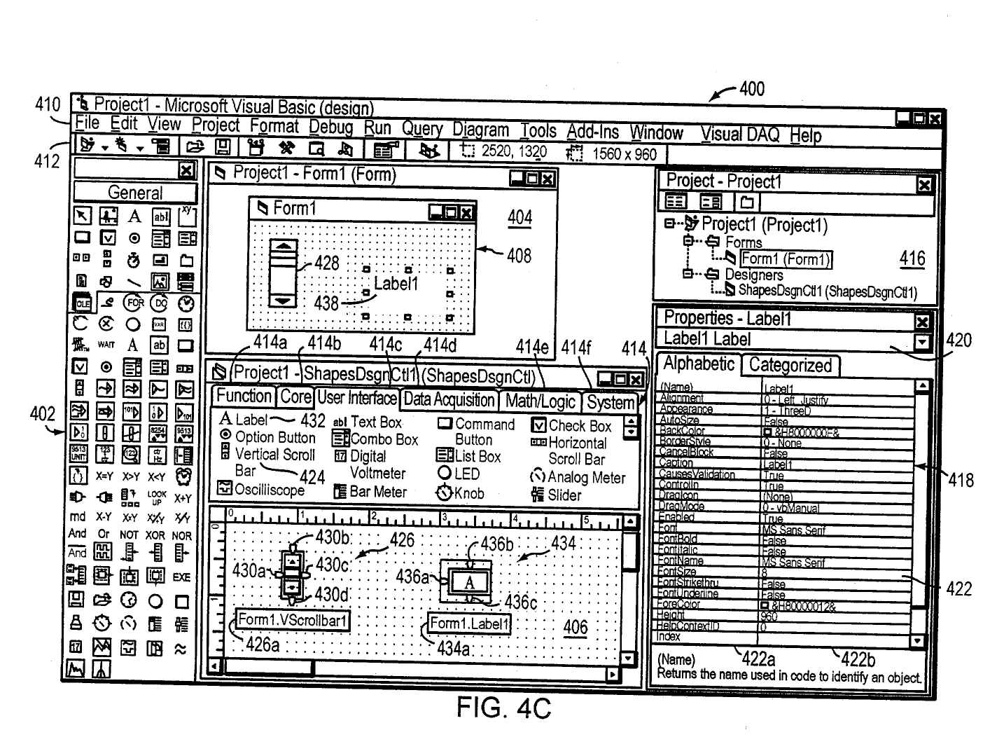

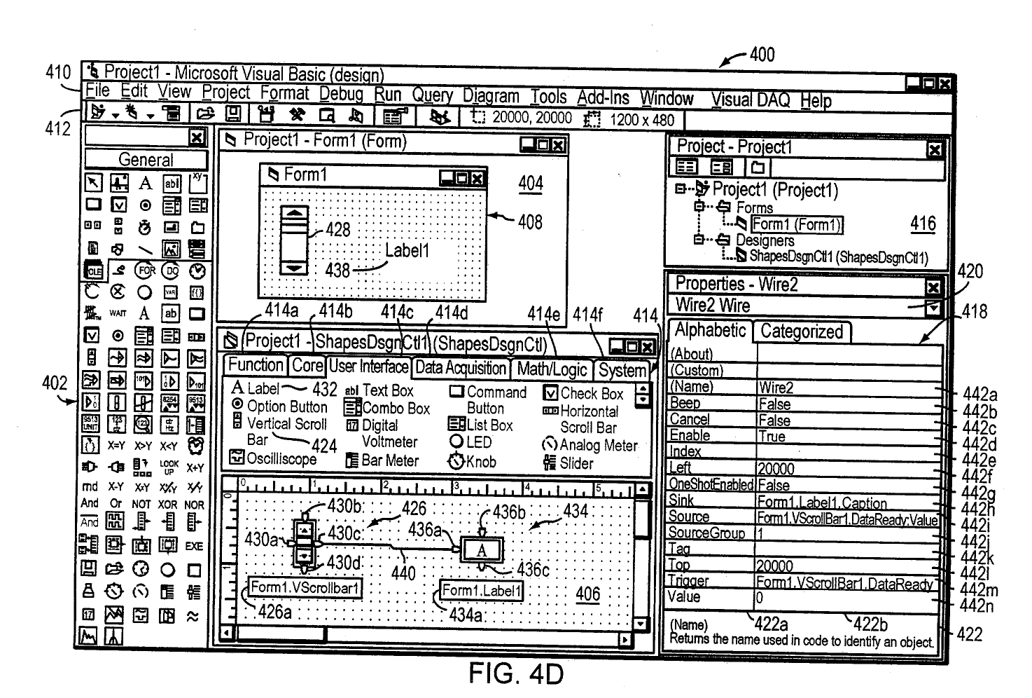

Upon opening, the graphical design system 314 cooperates with the visual programming system 312 to present a unified and coherent graphical user interface (GUI) to the developer on display screen 235 of monitor 232. FIG. 4A shows a preferred representation of this GUI 400. The GUI 400 has several elements, including at least one toolbox 402 that contains a plurality of icons. Each icon represents a corresponding component control or program object class that is available for use by the developer in creating application programs. The application programs that are ultimately created by the development environment 310 can be considered component-oriented, since they, among other things, call upon class factories that allocate memory for object members and ensure that the respective class methods have been loaded. The GUI 400 further includes one or more form windows 404 and a designer window 406. The form window 404 represents a container application that can “hold” instances of the control component or program object classes selected by the developer from the toolbox 402 for inclusion in the particular software program. By default, form window 404 includes a user form program object 408. The user form program object 408 basically provides an image of the user interface being developed for the application program. The GUI 400 may further include a menu bar 410 with a plurality of pull-down menu items and a toolbar 412 that contains a plurality of buttons providing short-cuts to commonly used tasks or functions.

As described below, the designer window 406 is configured to display a corresponding symbol for each program object added to the form window 404. These symbols, moreover, may be graphically linked together in order to create a two-dimensional block diagram that logically represents the application program that is being developed. The designer window 406 also includes its own toolbar 414, which may be divided into a plurality of sub-toolbars 414a-f, each having a corresponding tab that may be labeled (e.g., Function, Core, User Interface, Data Acquisition, Math/Logic and System). Disposed on each sub-toolbar 414a-f are one or more icons. Each icon represents a corresponding control component or program object class, the symbolic representation of which may be caused to appear in the designer window 406.

Each control component or program object instantiated from a corresponding class represented by an icon on toolbox 402 and/or toolbar 414 has pre-defined properties, methods and events. In addition, each program object typically performs some useful function, such as a Boolean operation (e.g., AND, OR, etc.), a mathematical operation, a data acquisition operation (typically from some transducer coupled to the I/O circuitry 218 of the computer 200), renders some comparison (e.g., less than, greater than, equal to, etc.), and so on. In the preferred embodiment, these control components or program objects are compatible with the ActiveX or Component Object Model (COM) technologies developed and made publicly available by Microsoft Corporation. The creation of ActiveX or COM objects is well-known to those skilled in the art and will not be described in detail here. For example, the creation of such objects is described in D. Appleman Developing COM/ActiveX Components with Visual Basic 6 (1999). The program objects and their classes may be stored in one or more dynamic link libraries (DLLs) within the memory 214 of the computer 200. The graphical designer system 314 and/or the visual programming system 312 preferably includes a link (e.g., a pointer) to these DLLs so that the available program object classes may be displayed as icons on the toolbox 402 and on the designer toolbar 414.

The program objects intended for use with the program-development environment 310 of the present invention are preferably pre-configured to have certain novel properties, methods and events. These additional properties, methods and events include the following:

PROGRAM OBJECT PROPERTIES

| Name | Data Type | Description |
|---|---|---|
| CancelBlock | Boolean | If set, prevents program object from |
| | | executing or from completing execution |
| | | of its function. |
| ControlIn | Boolean | When used, controls when program object |
| | | begins execution of its function. |
| InvalidProperty | Integer | Invalidates an identified property of |
| | | the program object in order to ensure |
| | | orderly execution. |

PROGRAM OBJECT EVENTS

| Name | Description |
|---|---|
| RunBlock | Occurs when program object is about to commence |
| | executing its corresponding function. |
| InvalidateGroup | Occurs when program object is about to up-date one |
| | or more of its properties as a result of executing |
| | its corresponding function. |
| DataReady | Occurs after program object has up-dated one or more |
| | of its properties as a result of executing its |
| | corresponding function. |
| RateReady | Issued by program objects that perform scanning |
| | operations upon successful completion of a scan. |
| StatusReady | For program objects that operate in one or more modes |
| | or states, this event occurs repeatedly while the |
| | program object executes its corresponding function. |
| ControlOut | Occurs when program object has completed execution. |
| ErrorOut | Occurs if program object generated an error during |
| | execution and may contain an identification of the |
| | type of error that was generated. It may also occur |
| | to indicate that no error condition was generated |
| | during execution. |

where Boolean means that the property may be set to True or False and Integer refers to any integer.

The GUI 400 may also include additional windows. For example, GUI 400 may include a project explorer window 416, which provides a hierarchical view of the current project. A project simply refers to the collection of files (e.g., form files, binary data files, class module files, etc.) and objects associated with the application program being developed. GUI 400 may also include a properties window 418 that displays the properties of a selected program object residing in the form window 404. The properties window 418 includes a pull-down object list 420, that contains a list of all of the program objects currently residing in the form window 404, and a property window 422, that is divided into two columns: a name column 422a and a current value column 422b. The name column 422a identifies all of the properties associated with the program object selected in the object list 420, while the current value column 422b shows the values that are currently associated with those properties.

To generate an application program, the developer selects one or more icons preferably from the designer toolbar 414 that perform requisite functionality for carrying out the tasks of the application program. In response, the program-development environment 310 places corresponding symbols in the designer window 406. The developer then graphically links these symbolic representations by drawing “wires” between them in order to create a two-dimensional graphical representation of the program. He or she will typically do this by using the mouse 230 (FIG. 2) or similar input device to cause the cursor 240 to move from one symbol to the next, although other graphical or even keyboard inputs may be used to perform the “graphical input”. In response, the graphical designer system 314 of the program-development environment 310 generates an event handler procedure to be run as part of the application program being developed. In accordance with the invention, the development environment 310 also includes in the same resultant application program other event handlers, which the developer optionally specifies textually by entering commands and other information in a code window that the development environment 310 also provides on GUI 400. That is, the development environment 310 gives the developer the option of using textual inputs in order to specify event handlers that might otherwise be impossible or more difficult to represent graphically.

Suppose, for example, that the developer wishes to create a simple software program in which the position of a vertical scroll bar is displayed in a label. From the User Interface designer sub-toolbar 414c, the developer first selects the vertical scroll bar icon 424. To select icon 424, the developer uses the mouse 230 (FIG. 2) to position the pointer 240 over the vertical scroll bar icon 424 and activates (e.g., “clicks”) the mouse button 234. This mouse click is a conventional windows event that is received by the operating system 302 (FIG. 3) in a conventional manner. Since the mouse click occurred over the designer window 406, operating system 302 passes this window event to the graphical designer system 314 of the program-development environment 310 by a communication mechanism represented by arrow 326, and the designer system 314 treats the windows event as a selection of the vertical scroll bar class by the developer.

As shown in FIG. 4B, in response to the selection of icon 424 from the User Interface designer toolbar 414c, the graphical designer system 314 causes a symbolic representation 426 of the program object corresponding to the vertical scroll bar class to be displayed in the designer window 406. The designer system 314 also issues a call to the visual programming system 312 through its extensibility object 316 as represented by the communication mechanism of arrow 320. This call directs the visual programming system 312 to instantiate a program object from the vertical scroll bar class and add that program object to the container application represented by the form window 404. That is, form window 404 may maintain a linked list of pointers to program objects that are considered to “belong” to the form, and in this list is placed a pointer to the vertical scroll bar program object that was instantiated. Since the vertical scroll bar is a user interface element, the visual programming system 312 also causes a vertical scroll bar image 428 to appear in the user form object 408. Vertical scroll bar image 428 basically corresponds to the way in which the vertical scroll bar user element will appear in the respective user interface at run-time of the application program being created. Vertical scroll bar image 428 may be moved and/or re-sized by the developer in a conventional manner.

As part of the process of adding a program object to the form window 404, the visual programming system 312 also assigns a name to that program object. The name may consist of the object's class followed by an integer, e.g., VScrollBar1 for the first vertical scroll bar added to form window 404. The name uniquely identifies the program object within the form 408. Upon adding the program object to the form window 404, the visual programming system 312 preferably returns the assigned name to designer system 314 by a communication mechanism represented by arrow 318. The program-development environment 310 may then display a name 426a as part of the symbolic representation 426 of the object in the designer window 406. The name displayed in designer window 406, e.g., Form1.VScrollBar1, may be derived by concatenating the name of the program object, e.g., VScrollBar1, with the name of the form window in which it resides, e.g., Form1.

As indicated, the symbolic representations appearing in designer window 406 are used by the developer to create a two-dimensional graphical representation that logically corresponds to the application program being developed. To facilitate the generation of such diagrams and the creation of corresponding event handlers by the program-development environment 310, each symbolic representation in designer window 406 preferably includes one or more terminals disposed about it. These terminals, moreover, are associated with some pre-defined combination of the properties, methods and/or events of the respective program object that is symbolically represented. Vertical scroll bar 426, for example, has four terminals 430a-d. In order to facilitate a generally left to right passing of data, and a top to bottom flow of execution control, the terminals of all symbolic representations appearing within the designer window 406 preferably conform to the following general rules. Terminals on the left side of a given symbolic representation, such as terminal 430a of vertical scroll bar 426, preferably correspond to a property used as an input by the respective program object. Terminals on the right side of a symbolic representation, such as terminal 430c of vertical scroll bar 426, preferably correspond to (i) an optional property generated as an output and (ii) an event of the respective program object. Terminals on the top of a symbolic representation, such as terminal 430b preferably correspond to a property which, when changed to a new value, triggers execution of the respective program object, and terminals on the bottom of a symbol, such as terminal 430d of vertical scroll bar 426 preferably correspond to an event that occurs when the respective program object has completed execution of its respective function.

The vertical scroll bar program object, for example, has a plurality of pre-defined properties, methods and events. In particular, the properties of the vertical scroll bar program object include: Enabled, Height, Width, Minimum, Maximum, Value, etc. The methods associated with the vertical scroll bar program object include Move, Drag, SetFocus, ShowHelp, Refresh, etc. The events associated with the vertical scroll bar program object include RunBlock, DataReady, ControlOut, etc.

Terminal 430a at symbol 426 is preferably associated with the vertical scroll bar's Value property. Terminal 430b is associated with the scroll bar's ControlIn property. Terminal 430c is associated with the vertical scroll's Value property and its DataReady event. Terminal 430d is associated with the object's ControlOut event.

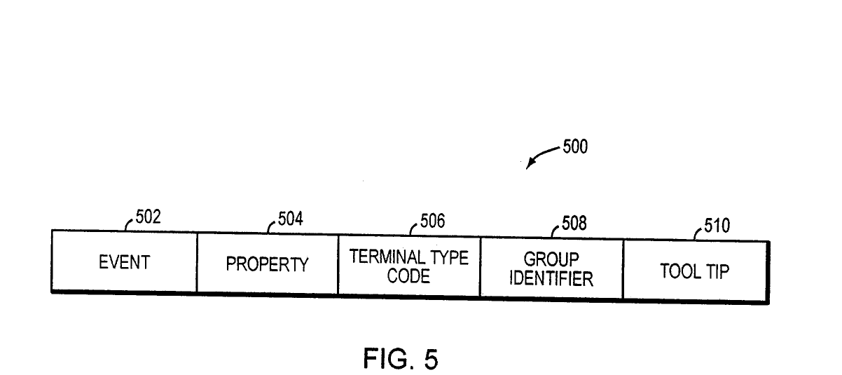

The association of properties and events to terminals is preferably maintained in a plurality of terminal data structures stored at memory 214 or 220. In particular, for each type or class of program object represented by an icon on the designer toolbar 414, there are one or more corresponding terminal data structures, depending on the number of terminals supported by the respective program object class. FIG. 5 is a highly schematic block diagram of a preferred terminal data structure 500. The terminal data structure 500 has at least four fields. A first field 502 preferably contains the name of the event, if any, that is associated with the particular terminal. A second field 504 preferably contains the name of the property, if any, that is associated with the particular terminal. If there is no event or property associated with the given terminal, then respective field 502 or 504 is set to null or de-asserted. A third field 506 preferably contains a code that identifies the particular type of terminal. In the illustrative embodiment, there are four types of terminals: data input, data output, control input and control output, and each type has a corresponding code. To the extent the data structure 500 corresponds to a data output type, a fourth field 508 is preferably used to store a group identifier. For a given type or program object class, the group identifier associates multiple data output type terminals whose corresponding properties are related to one another. For example, a joy stick object may have separate data output terminals for its “x” and “y” locations. Nevertheless, subsequent program objects should probably treat these two values as a single data point. Accordingly, the data output terminals associated with joy stick's “x” and “y” locations would preferably have the same group identifier. A fifth field 510 preferably contains a tool tip. A tool tip is a piece of descriptive text which is displayed to the developer when the cursor lingers over the respective terminal (e.g., “control input”, “error output”, and so on). The program-development environment 310 preferably maintains or otherwise has access to pointers to these various terminal data structures 500 within memory 214 (FIG. 2) (e.g., as a linked list). The pointers, moreover, may be mapped by the program-development environment to the names of the corresponding object classes so that, given the name of some object class, the program-development environment 310 can access the terminal data structures for each control or program object that has been instantiated from that class.

Symbolic representations appearing in the designer window 406, including the terminals, are preferably generated by the program-development environment 310 from respective bit maps stored in one or more image files within memory 214 (FIG. 2). The program-development environment 310 preferably maintains an association of bit maps to icons on the designer toolbar 414 so that when a developer selects a particular icon, the program-development environment 310 can direct the window manager 306 to draw the corresponding image from the appropriate bit map. Symbolic representations can also be moved about the designer window 406 by dragging them around with the mouse 230.

The developer then selects the next program object or control for use in the application program being created. Suppose that the developer selects the label icon 432 (FIG. 4B) from the User Interface sub-toolbar 414c. As shown in FIG. 4C, the program-development environment 310, in response, causes a symbolic representation 434 of a label program object to appear in designer window 406. Symbolic representation 434 also includes a plurality of terminals 436a-c, and may further include a name 434a. The program-development environment 310 additionally directs the visual programming system 304 to add a label program object to form window 404. Since the label program object is also a user interface element, like the vertical scroll bar, the visual programming system 304 additionally causes a label image 438 to be drawn on the user form object 408.

The label program object has its own pre-defined properties, methods and events. For example, the properties of the label program object include Height, Visible, Font, BackColor, Caption, ControlIn, CancelBlock, etc. Its events include RunBlock, ControlOut, etc. Data input terminal 436a of symbol 434, moreover, is preferably associated with the label's Caption property. Terminal 436b is associated with the ControlIn property, and terminal 436c is associated with the ControlOut event. Note that symbol 434 does not have any data output terminals.

Generation of Event-Handler Code Through Graphical Inputs

At this point, the developer has two program objects residing in the form window 404. With the prior art systems, such as the Visual Basic® programming system from Microsoft Corporation, the developer would now have to write one or more textual event handlers in order to have the position of the vertical scroll bar displayed in the label. As described above, the need to learn the keywords and syntax governing such textual event handlers has been a drawback to the use of Visual Basic by non-programmers, including scientists and engineers. With the program-development environment 310 of the present in vention, the developer may cause the development environment 310 to generate corresponding handler procedure by simply graphically linking the symbolic representations of the program objects in the designer window 406 with one or more novel wire constructs. The developer need not generate any text-based code at all. Unlike the prior-art systems that only enable the user to graphically provide event handlers, though, the program-development environment 310 of the present invention also affords the developer the ability to provide or modify event handlers textually. It thereby frees the developer of the constraints and limitations imposed by such prior-art graphical programming tools.

To cause the position of the vertical scroll bar image 428 to be displayed in the label image 438 at application run-time, the developer graphically links the symbolic representation 426 of the vertical scroll bar program object to the symbolic representation 434 of the label program object using a wire construct, rather than writing a textual event handler. To connect symbols 426, 434 with a wire construct, the developer moves the cursor 240 (FIG. 2) to terminal 430c (FIG. 4C) at symbol 426 using the mouse 230. As described above, terminal 430c is associated with both the DataReady event and the Value property of the respective vertical scroll bar program object, i.e., VScrollBar1, which resides on the form window 404. With the cursor 240 over terminal 430c, the developer preferably executes a mouse click using mouse button 234. Since this mouse click occurred in the designer window 406, the operating system 302 (FIG. 3) passes the respective windows event to the designer system 314 by the communications mechanism represented by arrow 326. In response, the designer system 314 directs the operating system 302 to switch the mouse 230 from “cursor mode” to “line drawing mode” through a call via arrow 328. In particular, designer system 314 directs the operating system 302 to modify the appearance of the cursor 240 and to begin tracing subsequent mouse 230 movement with a line, whose first end is anchored to terminal 430c. Thus, as the developer drags the mouse 230 away from symbolic representation 426, a line emanates from terminal 430c following the movement of the mouse 230.

The developer preferably extends this line to terminal 436a of symbolic representation 434, which corresponds to label program object Label1 residing on form window 404. When the free end of this line reaches terminal 436a, the developer preferably executes a second mouse click. Again, the corresponding windows event is passed by the operating system 302 to the designer system 314 and it, in response, causes the free end of the line to become attached to terminal 436a. Designer system 314 also directs the operating system to stop tracing mouse movement with a line and to return the cursor 240 to its original appearance. FIG. 4D is an illustration of the GUI 400 with a wire construct 440 extending between the two symbolic representations 426, 434.

In response to graphically connecting or linking two symbols in the designer window 406, the program-development environment 310 creates event handler program code that sets the label object's Caption property to the value of the vertical scroll bar object's Value property when the vertical scroll bar object's DataReady event occurs. Clearly, there are several ways in which this can be accomplished. For example, Visual Basic code for handling the indicated event (e.g., DataReady) and affecting the designated property (e.g., Caption) could be generated and added to the application program, and that event handler program code could then be compiled or interpreted in the normal manner at run-time. Preferably, though, the program-development environment 310 instantiates a new control or program object, a wire program object, adds this new object to the form window 404 and sets its properties in a predetermined manner. The basic function of the wire program object is to retrieve the Value property from the vertical scroll bar object in response to the DataReady event and to set the Caption property of the label program object to that Value. That is, this new object basically provides event handler functionality for other program objects residing in the form window 404.

Specifically, the graphical designer system 314 directs the visual programming system 312 through calls to its extensibility object 316, as arrow 320 indicates, to instantiate a wire component control or program object from the wire object class and to add this object to the form window 404. That is, form window 404 adds a pointer to the wire program object to its linked list of controls. It should be understood that the wire construct 440 appearing in the designer window 406 is preferably just a symbolic representation of the wire program object added to the form window 404. The visual programming system 312 also assigns a name to this program object, e.g., Wire2, which it returns to the designer system 314. As described below, as part of its initialization procedure, designer system 314 preferably directs the visual programming system 312 to instantiate and add a wire program object, which may be named Wire1, to the form window 404. Thus, the “first” wire that is drawn on the designer window 406 by the developer actually corresponds to the second wire program object to be instantiated and added to the form-window 404. Therefore, this wire program object is typically assigned the name Wire2.

The wire control or program object is itself a program module having its own predefined properties, methods and events. In the illustrative embodiment, each wire control or program object has the following properties, methods and events:

WIRE CONTROL PROPERTIES

| Name | Data Type | Description |
|---|---|---|
| Name | Text | Specifies the name of the wire program |
| | | object. |
| Beep | Boolean | Determines whether the wire program |
| | | object emits a “click” sound |
| | | whenever it is triggered. |
| Cancel | Boolean | Determines whether the wire program |
| | | object executes upon being triggered or |
| | | invoked. |
| Enabled | Boolean | Determines whether the wire program |
| | | object executes in response to its |
| | | triggering event. |
| Index | Text | Distinguishes between two or more wire |
| | | program objects having the same name. |
| Left | Integer | Specifies the x-coordinate position of |
| | | an image of the wire program object |
| | | appearing on the user form object. |
| OneShotEnabled | Boolean | If Enabled property is False, determines |
| | | whether the wire program object should |
| | | nonetheless execute one time. |
| Sink | Text | The name of the sink program object and |
| | | its respective property to which the wire |
| | | program object is graphically connected. |
| Source | Text | The name of the source program object |
| | | and its respective property to which |
| | | the wire program object is |
| | | graphically connected |
| SourceGroup | Integer | Used to organize related properties |
| | | of the source program object. |
| Tag | Text | Assigns an additional identifier to the |
| | | wire program object, typically for use by |
| | | the application program. |
| Top | Integer | Specifies the y-coordinate position |
| | | of an image of the wire program object |
| | | appearing on the user form object. |
| Trigger | Text | The name of the program object and |
| | | its respective event, the occurrence of |
| | | which causes the wire program object |
| | | to execute. |
| Value | Variant | A data store, the contents of which can be |
| | | copied from the source, modified, if |
| | | desired,and passed to the sink by the |
| | | wire program object. |

WIRE CONTROL METHODS

| Name | Description |
|---|---|
| Run | Causes the wire program object to execute. |

WIRE CONTROL EVENTS

| Name | Description |
|---|---|
| Action | Occurs in response to the wire program being triggered or run. |
| (Value) | The argument corresponds to the current value of the wire's |
| | Value property prior to any event handling routines. |
| Done | Occurs once the wire program object has finished propagating its |
| | Action event and setting the specified sink property, provided |
| | that the Cancel property is still false. |

where Boolean means that the property may be set to True or False, Text means that the property is an alpha-numeric string, Integer means that the property is an integer, and Variant means that the property can take any of the data formats specified by the corresponding variant structure definition.

After the visual programming system 312 has added the wire program object to the form window 404 and returned its name, the designer system 314 next sets the various properties of this wire program object. The wire's properties, moreover, may be displayed in the property window 422 (FIG. 4D) of property window 418, as indicated by rows 442a-n, by selecting the wire program object, e.g., Wire2, from pull-down object list 420. The particular values to which the wire's properties are initially set depends on the particular program objects that have been logically connected by the wire construct 440 within designer window 406. For each wire control or program object, the designer system 314 identifies three corresponding program objects: a “source” program object, a “sink” program object and a “trigger” program object. Designer system 314 also examines the terminal data structures 500 that are associated with the graphically linked terminals 430c and 436a. Designer system 314 then uses this information to set the properties of the respective wire program object, i.e., Wire2.

It should be understood that attempts by the developer to wire a first input terminal to a second input terminal or a first output terminal to a second output terminal are rejected by the program-development system 310.

To identify the source, sink and trigger program objects, designer system 314 determines the names of the program objects that have been linked by the subject wire construct 440, the form window(s) on which those program objects reside, and the particular types of terminals that have been graphically linked by wire construct 440. As indicated above, information regarding the names of the graphically linked program objects and the form window(s) on which they reside is returned to the designer system 314 by the visual programming system 312 when system 304 adds those program objects to the form window 404. Thus, designer system 314 already has this information in its allocated portion of memory 214. Information regarding the types of terminals that have been linked is derived by the designer system 314 from the terminal type code fields 506 for the terminal type data structures 500 associated with the respective terminals, i.e., terminals 430c and 436a. The designer system 314 uses this terminal type information to determine which of the linked program objects should be considered the source object, which program object should be considered the sink object, and which program object should be considered the trigger object. In the preferred embodiment, the program object whose linked terminal is either a data output or control output type is treated as the source object, while the program object whose linked terminal is a data input or control input type is treated as the sink object. Here, linked terminal 430c at symbolic representation 426 is a data output terminal, while terminal 436a at symbolic representation 434 is a data input terminal. Thus, the designer system 314 considers the VScrollBar1 program object to be the source object and the Label1 program object to be the sink object for respective wire object, i.e., Wire2.

After identifying the source and sink control objects, the designer system 314 is ready to set the Sink, Source and Trigger properties 442h, 442i and 442m of Wire2. The wire program object's Source property is preferably a concatenation of the following information: the name of the form window 404 on which the source program object resides, e.g., Form1, the name of the source program object, e.g., VScrollBar1, and the property associated with the linked terminal at the source program object, e.g., Value. The Source property may further be concatenated with the event associated with the linked terminal at the source program object, e.g., DataReady. The designer system 314 preferably obtains the source event and property parameters for use in setting the wire's Source property from the event field 502 and property field 504 from the terminal data structure 500 associated with linked terminal at the source program object, i.e., terminal 430c. For data output type terminals, such as terminal 430c, system 314 similarly obtains the Source-Group property parameter 442j from the group identifier field 805 from the corresponding terminal data structure 500.

The wire program object's Sink property 442h is preferably a concatenation of the following information: the name of the form window 404 on which the sink program object resides, e.g., Form1, the name of the sink program object, e.g., Label1, and the property associated with the linked terminal at the sink program object, e.g., Caption. Again, the designer system 314 preferably obtains the sink property parameter from the property is field 504 of the terminal data structure 500 associated with linked terminal at the sink program object, i.e., terminal 436a. The wire program object's Trigger property 442m is preferably a concatenation of the following information: the name of the form window 404 on which the source program object resides, e.g., Form1, the name of the source program object, e.g., VScrollBar1, and the event associated with the linked terminal at the source program object, e.g., DataReady. As described above in connection with setting the Source property, this information may be derived from the name of the source program object and also from the contents of the event field 502 of the terminal data structure 500 associated with linked terminal at the source program object, i.e., terminal 430c. It should be understood that the designer system 314 may derive and set the Source property 442i first and then strip off the specified property of the source (e.g., Value), which was obtained from field 504 of the corresponding terminal data structure 500, to set the Trigger property 442m.

The wire program object preferably includes built-in functionality that automatically sets its Beep, Cancel and OneShotEnabled properties 442b, 442c and 442g to FALSE, and its Enabled property 442d to TRUE. The Value property 442n is preferably set, at least initially, to null or is otherwise de-asserted.

In the preferred embodiment, wire program objects are not intended to appear in any of the user interfaces that may be generated at run-time of the application program being developed. Accordingly, the Left and Top properties 442f, 442l of all wire program objects, which specify where on the user form object 408 an image of the object should appear (and, hence, where on the run-time user interface those images should appear), are set to default values (e.g., “20000”) that are sufficiently high so as to “place” the image of the wire program objects off of the user form object 408. Thus, at run-time, no image appears on the user interface corresponding to any wire program object that may nonetheless reside on the corresponding form window. Additionally, or alternatively, the wire object's Visible property may be set to FALSE.

Each wire program object instantiated and added to the form window 404 in response to graphical inputs of the developer includes at least some program code that may be called upon to execute when the respective application program is run. This program code, which is generated solely in response to the developer having graphically linked the symbolic representations of two program objects, basically causes the sink program object, e.g., Label 1, to execute or otherwise take some action in response to an event generated by a trigger program object, e.g., VScrollBar1, and using some property of the source control object. That is, the wire object represents event handler procedures or code incorporated within the application program.

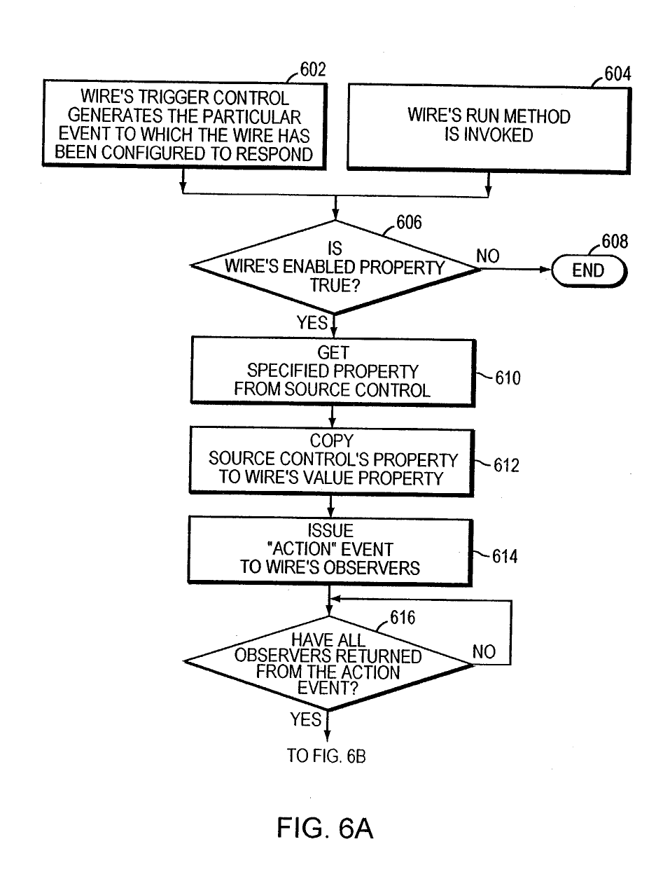

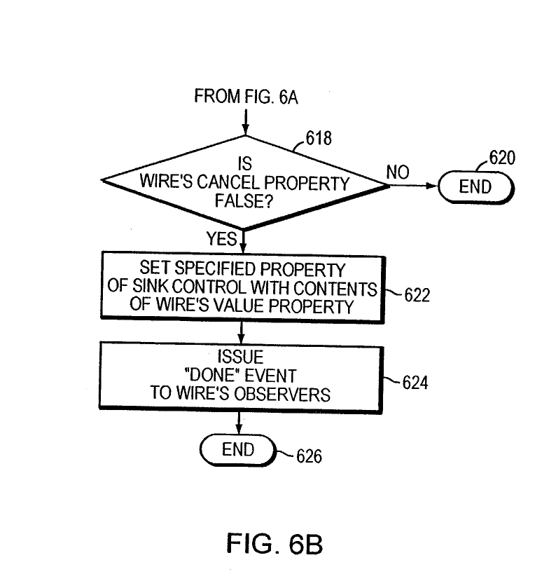

FIGS. 6A and 6B are a flow diagram of the steps corresponding to the preferred event handler procedure or code generated by the program-development environment 310 in response to such graphical inputs from the developer. This procedure may be called upon to execute during run-time of the application program. Running of the graphically generated event handler procedure may be initiated in one of two ways. First, it is initiated when the trigger control component, as identified in the wire's Trigger property 442m, e.g., VScrollBar1, issues the particular event also identified in the wire's Trigger property 442m, e.g., DataReady, as indicated by block 602. In order to learn of the occurrence of this event (e.g., DataReady), the wire program object preferably registers with the trigger program object using an Event_Advise_Notification( ) method having the desired event as an argument. In response, the VScrollBar1 object notifies Wire2 whenever its DataReady event occurs. Alternatively, the event handler procedure may be initiated by invoking the wire's Run method, as indicated by block 604. Following initialization, the next step is to determine whether the wire program object's Enabled property 442d is TRUE, as indicated at block 606. If the wire's Enabled property 442d is FALSE, the code preferably ends, as indicated by first end block 608. As explained above, when the wire program object is first instantiated, it sets its Enabled property 442d to TRUE. Thus, unless the Enabled property 442d was subsequently set to FALSE at some point during run-time, as explained below, or was re-set by the developer, the response to decision block 606 is typically yes.

As indicated at block 610, the event handler procedure next retrieves the value of the property specified in the wire's Source property 442i, e.g., Value, from the source object, e.g., VscrollBar1, also identified in the wire's Source property 442i. To do this, a Get( ) method may be invoked on the source program object. A separate Get( ) method may be invoked for each readable property. The Get( ) method is a conventional method that is preferably supported by all of the component controls or program objects utilized by the program-development environment 310 of the present invention. As an argument to the Get( ) method, the code inserts the name of the property, e.g., Value, the value or setting of which is to be returned. Suppose the current setting of the VScrollBar1's Value property is “15”. Then, in response to the Get( ) method, the VScrollBar1 returns “15” to the wire program object. This value may be returned to the wire program object through either a Pass_By_Value or Pass_By_Reference communication method, both of which are well-known to those skilled in the art. The wire program object next copies this value, i.e., “15” to its own Value property 422n, as indicated at block 612. Upon copying the value into its Value property, the wire program object preferably issues its Action event, as indicated at block 614. Other elements or processes of the application program, including other component controls or program objects, may register as “observers” with the wire program object using the Event_Advise_Notification method described above so as to be notified of the wire's Action event. These observers may respond to the wire's Action event in any number of ways. At decision block 616, the wire program object waits until all of these “observers” have indicated that they have finished processing the wire's Action event.

Next, the wire program object queries whether its Cancel property 442c (FIG. 4D) is FALSE, as indicated at block 618. As explained above, when the designer system 314 first sets the properties of a wire program object, it sets the Cancel property 442c to FALSE. In response to the wire's Action event (or some other event), however, another process, control component or program object may change the wire's Cancel property 442c from FALSE to TRUE. If the wire's Cancel property 442c is TRUE, then execution stops as indicated by second end block 620. Assuming the wire's Cancel property 442c is still FALSE, then the wire next up-dates the Sink property 442h, i.e., Caption, with the current value of its own Value property 442n, as indicated at block 622. This may be accomplished by invoking a Seto method on the sink control identified by the wire's Sink property 442h, i.e., Label1. A separate Set( ) method may also be invoked for each settable property. The Set( ) method is another conventional method supported by all of the component controls or program objects utilized in the program-development environment 310 of the present invention.

After setting the sink's property, the code corresponding to the wire program object issues a Done event, as indicated at block 624. Observers may similarly register with the wire program object, again using the above-described Event_Advise_Notification method, so as to be notified of its Done event. These observers may be configured to take any number of different actions in response to the wire's Done event. At this point, the wire program object has finished executing as indicated by third end block 626.

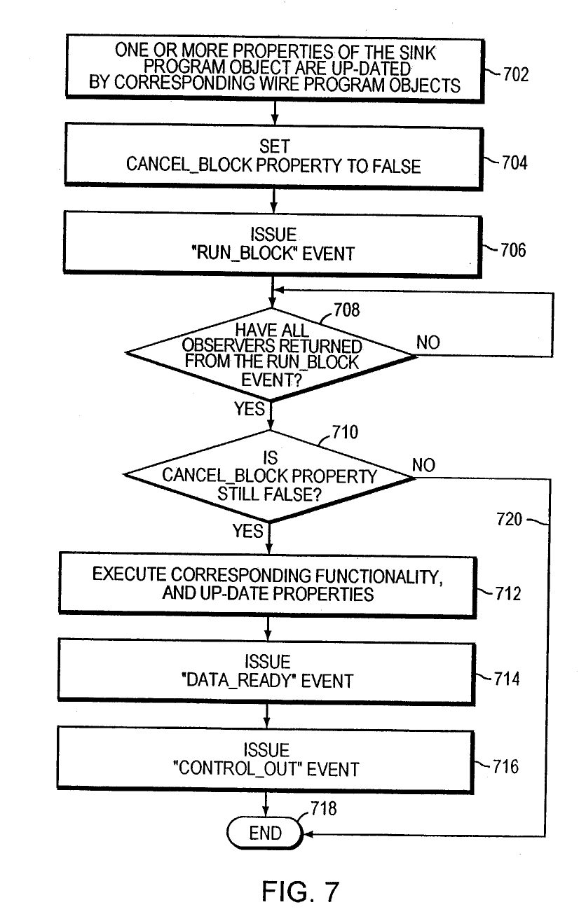

FIG. 7 is a flow diagram of steps preferably executed by a typical program object, such as the Label1 program object, incorporated in the application program being developed during application run-time. The program object begins execution in response to one or more of its properties being up-dated by a corresponding wire object as indicated at block 702, such as when the Wire2 object up-dates the Caption property of Label1. Next, the program object sets its CancelBlock property to FALSE as indicated at block 704. The program object then issues its RunBlock event as reflected at block 706. As with the Action and Done events issued by the wire program objects, observers (including wire program objects) may register with the program object using the Event_Advise_Notification mechanism so as to be notified of its RunBlock event. These observers may interact with the program object by, for example, changing its properties etc. As indicated by decision block 708, the program object waits until all such observers have returned from its RunBlock event.

Next, the program object determines whether its CancelBlock property is still FALSE as indicated at decision block 710. One or more of the observers could have set the program object's CancelBlock property to TRUE in response to processing the Run-Block event. If its CancelBlock property is still FALSE, the program object executes its corresponding functionality and up-dates its own corresponding properties as warranted as indicated by block 712. Upon up-dating its properties, the program object issues its DataReady event as indicated by block 714. To the extent a wire program object is connected to one of this program object's data output terminals, the issuance or occurrence of the DataReady event may trigger that wire program object to begin operation. After issuing its DataReady event, the program object next issues its ControlOut event as indicated by block 716. To the extent the program object's control output terminal is connected to a wire construct, the corresponding wire may begin operation. Execution of the program object is now complete as reflected by End block 718. If, in response to decision block 710, the program object's CancelBlock property is TRUE, then processing stops at that point as indicated by No arrow 720 leading from decision block 710 to End block 718.

It should be understood that a given program object may execute its corresponding functionality, as described at step 712, and then issue a RunBlock event, as described at step 706. This may be implemented by objects that perform mathematical operations, for example, and are thus less likely to cause erroneous data propagation problems in the corresponding application program. It should be further understood that, depending on the type of program object, other events besides DataReady may be issued. For example, program objects that operate in discrete or determinative modes or states, such as the For Loop, Do Loop and Wait objects, described below, or an Analog In Scan object, may issue one or more StatusReady events in place of the DataReady event. Program objects that perform scanning functions, such as Analog In Scan or Analog Out Scan, may issue a RateReady event in place of the DataReady event. Those skilled in the art, moreover, will recognize that other such events may be defined and implemented by the program objects utilized with the program-development environment 310.

Generation of Event-Handler Code Through Textual Inputs

A significant advantage of the present invention is its ability also to generate event handler procedures or code in response to textual inputs by the developer. In some circumstances, for example, it may be more efficient to specify an event handler textually rather than graphically. In particular, following the example of FIGS. 4A-D, suppose the developer wishes to have the background color of the label image 438 turn red during run-time whenever the value to be displayed exceeds 15000. Although the label object has a BackColor property, in the absence of a specific terminal on the corresponding symbolic representation 434 for the Label1 program object that is associated with this property, it would be difficult to specify this functionality graphically. Indeed, with the prior art graphical program languages, such as HP VEE and LabVIEW, it would be extremely difficult, if not impossible, to provide this functionality, because the graphical images for the label program object provided by these prior art systems do not have a terminal or pin for setting the object's background color in response to the value of its Caption property.

With the present invention, the program-development environment 310 allows the developer to switch to a textual programming paradigm in order to specify an event procedure or other functionality that is more easily described textually as opposed to graphically. To specify an event handler textually, the developer directs the program-development environment 310 to call-up and display a code window in which textual inputs may be entered by the developer. More specifically, the developer, using mouse 230, moves the cursor 240 (FIG. 2) over the symbol of interest, e.g., Label symbol 438 (FIG. 4D), as displayed in the designer window 406 and executes a double mouse click. Since the cursor 240 is over the designer window at the time of the mouse click, the operating system 302 (FIG. 3) preferably passes the respective windows event to the graphical designer system 314. In response, the designer system 314 issues a call to the visual programming system 312, via arrow 320, causing it to display a code window on GUI 400 (FIG. 4D).

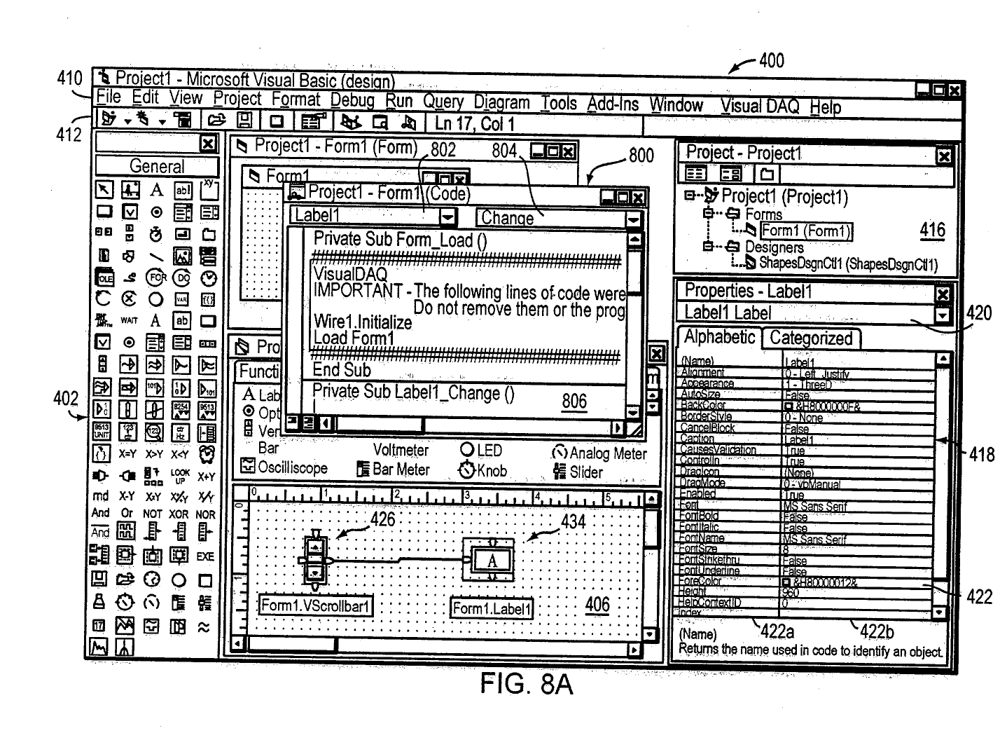

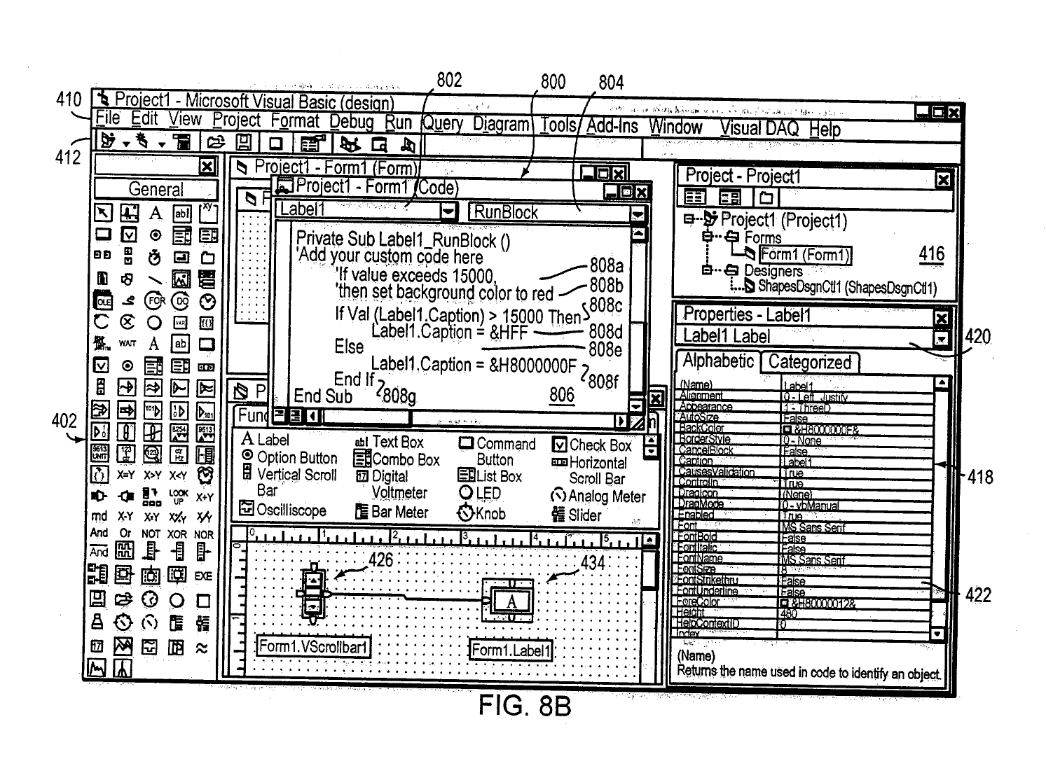

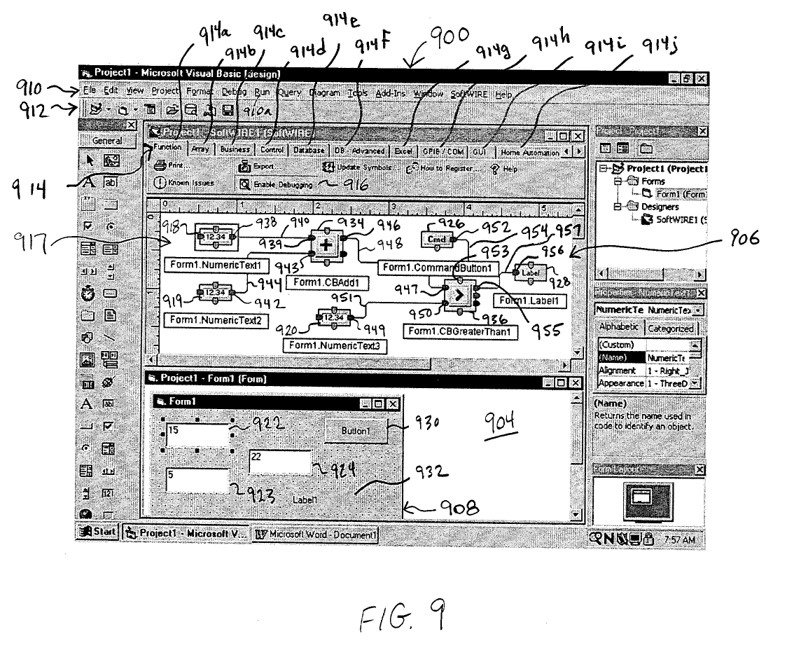

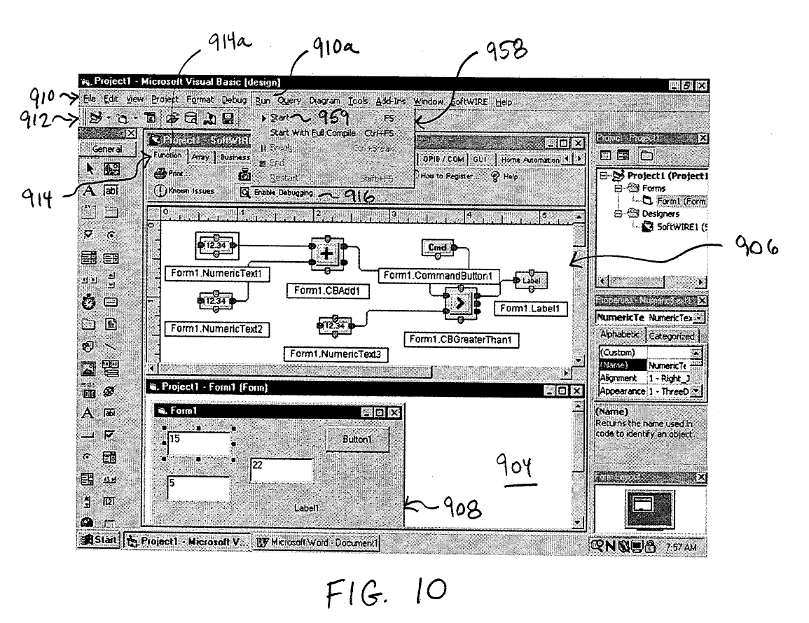

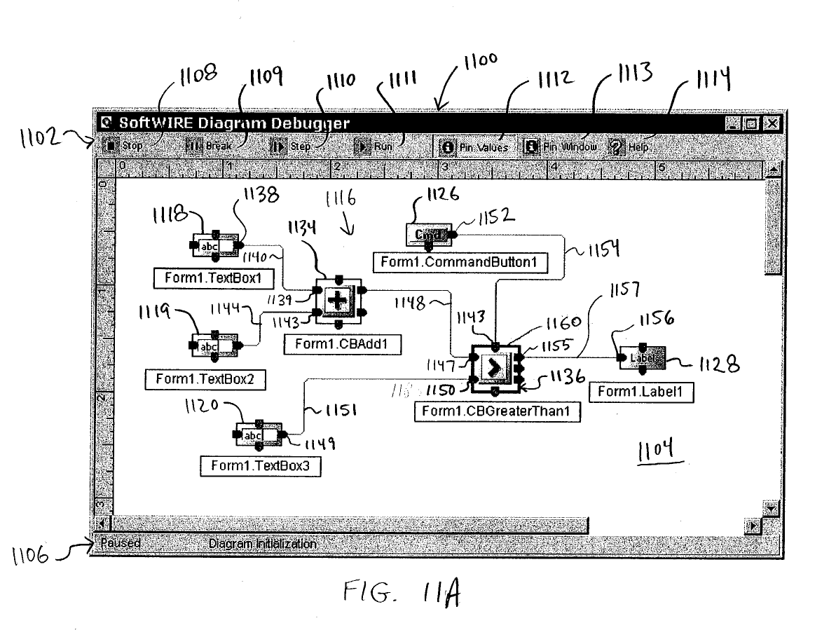

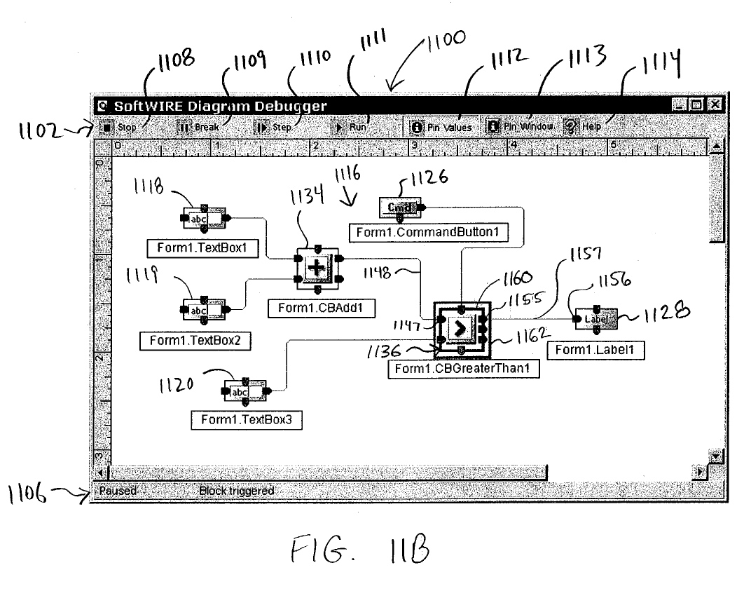

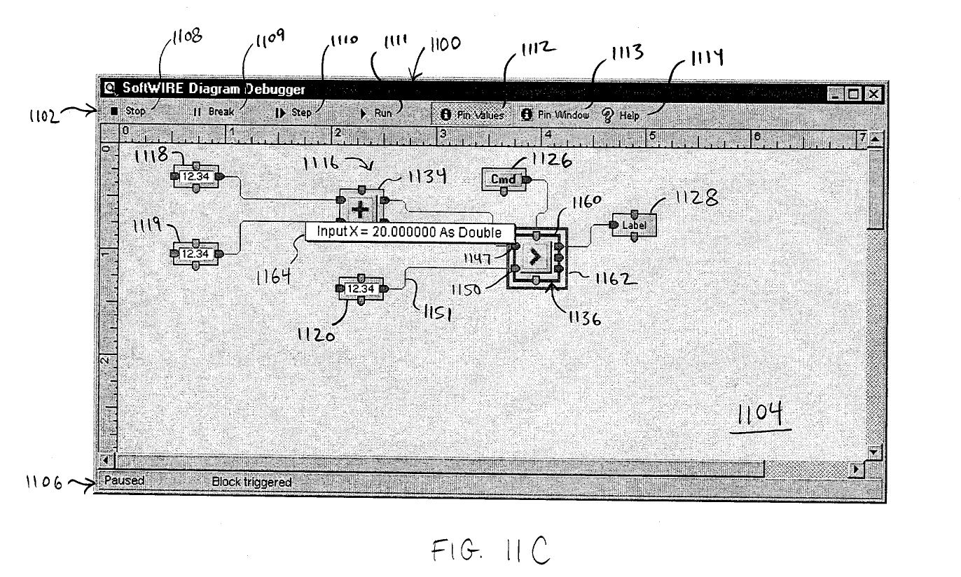

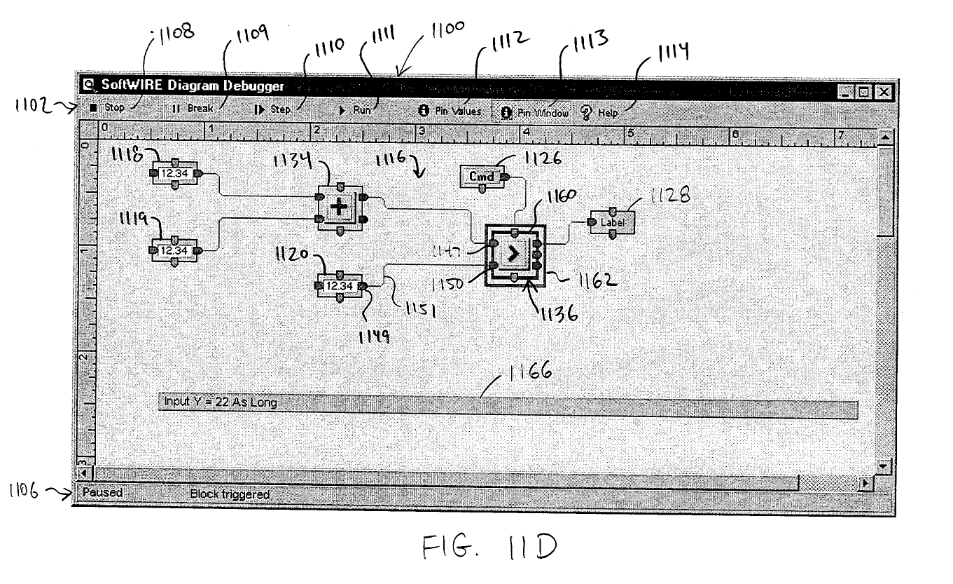

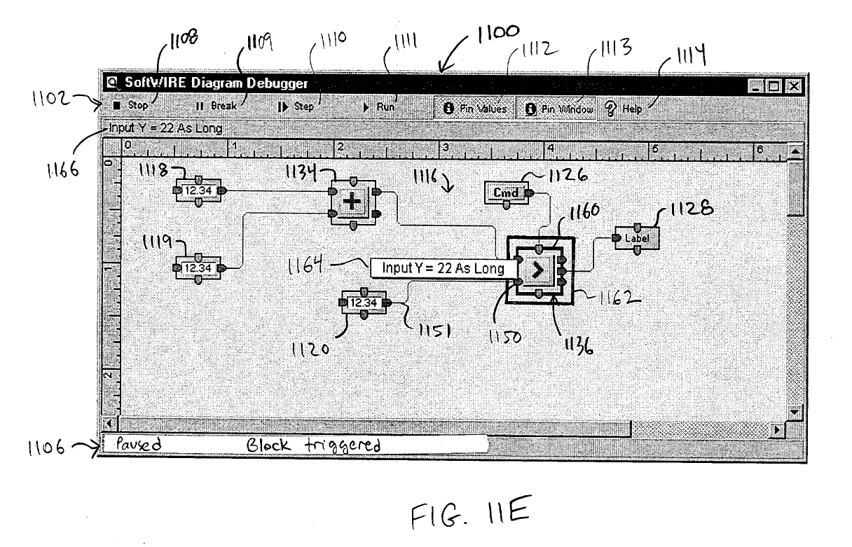

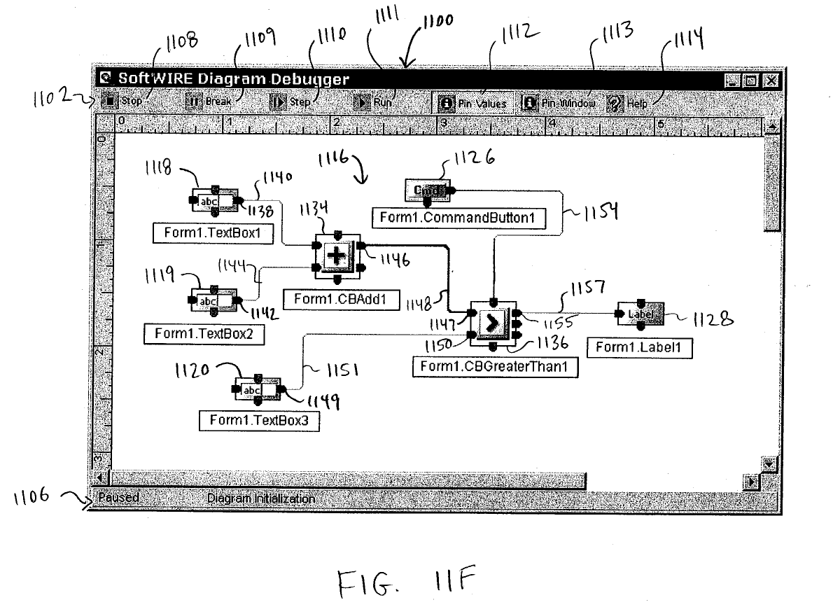

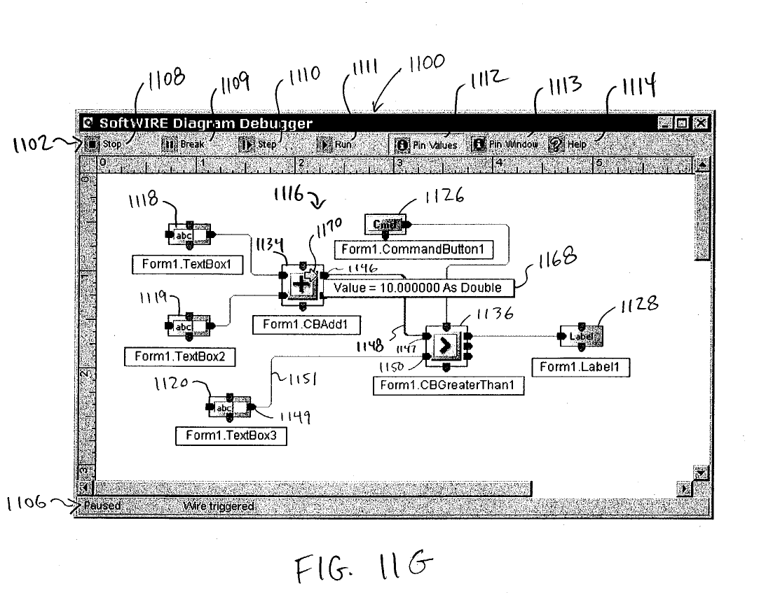

FIG. 8A is a preferred illustration of the GUI 400 of FIG. 4D further including a code window 800. Code window 800 includes a pull-down object box 802, which contains a list of all of the program objects currently residing in the form window 404. By default, the object box 802 initially displays the program object selected by the developer, e.g., Label1. Code window 800 further includes a pull-down procedures/events box 804, which contains a list of all of the procedures and events supported by the selected program object of object box 802. Selecting a particular procedure or event from box 804 positions the entry point for subsequent textual inputs at the first line of the respective procedure or event. The procedures/events box 804 may initially display the first event supported by the corresponding object, e.g., the Change event, which is issued when an object's Value property changes. Code window 800 further includes an input area 806. Within the input area 806, the developer can write, review and edit program code for the respective application program using the keyboard 224 to generate textual inputs. In the preferred embodiment, the developer enters one or more statements within input area 806. A statement is basically a syntactically complete unit that expresses some action, declaration or definition. A statement generally occupies a single line, although a first designated symbol, e.g., the colon (“:”), may be used to include more than one statement on a line, and a second designated symbol, e.g., the line-continuation character (“_”), may be used to continue a single logical line onto a second physical line.

FIG. 8B is a preferred representation of the GUI 400 after the developer has written a series of statements 808a-g into the input area 806 of the code window 800 following the selection of the RunBlock event from the procedures/events box 804. As indicated above, statements 808a-g comply with the keywords and syntax defined by the programming language supported by the visual programming system 312 of the program-development environment. In the illustrative embodiment, this programming language is Microsoft's Visual Basic. Statements 808c-g specify the functionality for turning the background color of the label image 438 red if its Caption property (which is set to the Value property of VScrollBar1) exceeds 15000. Statements 808a-b are simply comment statements that describe the functionality to be carried out by the subsequent statements.

In response to entering one or more statements in the input area 806 of code window 800, the program-development environment 310 generates constituent program code for insertion in the corresponding application program. That is, at run-time, the statements 808a-g are compiled or interpreted and executed as required, thereby implementing the functionality of the corresponding statements.

Those skilled in the art will understand that the code window 800 may be called-up in other ways. For example, the developer may choose the “Code” option (not shown) from the View command of menu bar 410.

It should be understood that a developer may also display and edit the properties of a wire program object, thereby causing the program-development environment 310 to modify the corresponding event handler procedure. As described above, the developer may cause the properties of a wire object, e.g., Wire2, to be displayed in the properties window 418 of GUI 400. By selecting one of the properties listed in the property window 422 of window 418, typically through a mouse click, the developer can edit the selected property. For example, although the wire program object preferably sets its Beep property 442b to FALSE upon instantiation, the developer may re-set this property to TRUE through textual inputs entered in the property window 418. In response, the event-handler procedure generated by the program-development environment 310 causes the computer system 200 to sound a tone each time the wire program object executes.

The developer may also change a given wire object's trigger property 442m to a different event and/or a different program object. More specifically, as described above, the program-development environment 310 sets the trigger property 442m of a wire program object based on the particular source terminal, e.g., terminal 430c, to which the wire construct 440 of the corresponding wire program object, e.g., Wire2, is connected. The wire program object, moreover, executes in response to the occurrence of the event specified in its trigger property 442m. By editing the trigger property 442m, a developer may cause the program-development environment 310 to modify the corresponding event handler procedure such that the wire program object now executes in response to some newly identified event and/or program object (e.g., an object other than the wire's source object). To prevent developer-induced errors, the program-development environment 310 may be configured to block the display (and thus the editing) of wire program object properties through property window 418.

Although the program development environment 310 of the present invention involves graphical event handler code generation, some implementations may not provide that capability for all available control components or program objects that may be incorporated into a given application program. Or, they may provide different toolbox icons or elements for the same control components, some of which enable the developer to program the control's event handlers graphically and others that do not. In such implementations, the toolbox 402 (FIG. 4A) may be divided into two areas. A first area 402a contains a plurality of icons corresponding to program object classes that can only be used in the form window 404. The program objects corresponding to these icons do not have a corresponding symbolic representation for use in the designer window 406. A second area 402b contains a plurality of icons that can be used in both the form window 404 and the designer window 406. That is, the program objects corresponding to these icons include symbolic representations capable of display in the designer window 406.

It should be understood that program objects need not include all of the above-specified properties or events. For example, program objects may not have an Invalid-Property property or a StatusReady event. Furthermore, rather than a single RunBlock event, program objects may have a PreRunBlock event, which occurs when the program object has latched its input properties and is ready to perform its primary function, and a PostRunBlock event, which occurs after the program object has executed its primary function and is ready to update its output property(ies). In addition, various of the properties, methods and events may be given different names.

The wire controls may also be defined without all of the above-identified properties, methods or events. For example, the wire controls may be without index, left, right or tag properties. Furthermore, rather than including the property of the sink object in the wire control's Sink property, a new property, known as the SinkProperty, may be provided, which corresponds to the name of the sink program object's respective property to which the wire control is graphically connected. Similarly, rather than include the source property as part of the wire control's Source property, a new property, known as the SourceProperty, may be provided, which corresponds to the name of the source program object's respective property to which the wire control is graphically connected. Those skilled in the art will recognize that other changes may also be made.

Diagram Debugger

As indicated above, the graphical designer system 314 of the present invention includes a debugger utility 315 that can be invoked by the developer in order to debug the application program being created. The debugger utility 315 allows break points to be inserted on any of the pins, wires or blocks of the block diagram so that execution of the application program can be paused at those selected intermediary points, thereby allowing the developer to examine the state of the program at various points or levels of execution. In particular, the developer can examine the values associated with various pins and wires at each of these intermediary points. A break point insertion tool, moreover, allows the developer to specify the break points graphically, rather than through textual inputs. Additionally, the developer can use the debugger utility 315 to step through the program to check the order or sequence in which the controls and form the application program execute.

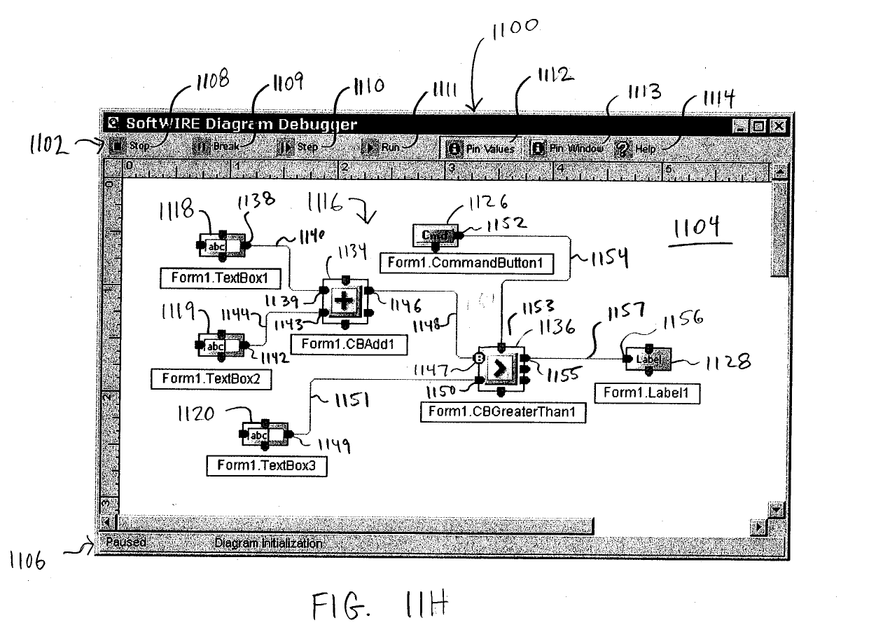

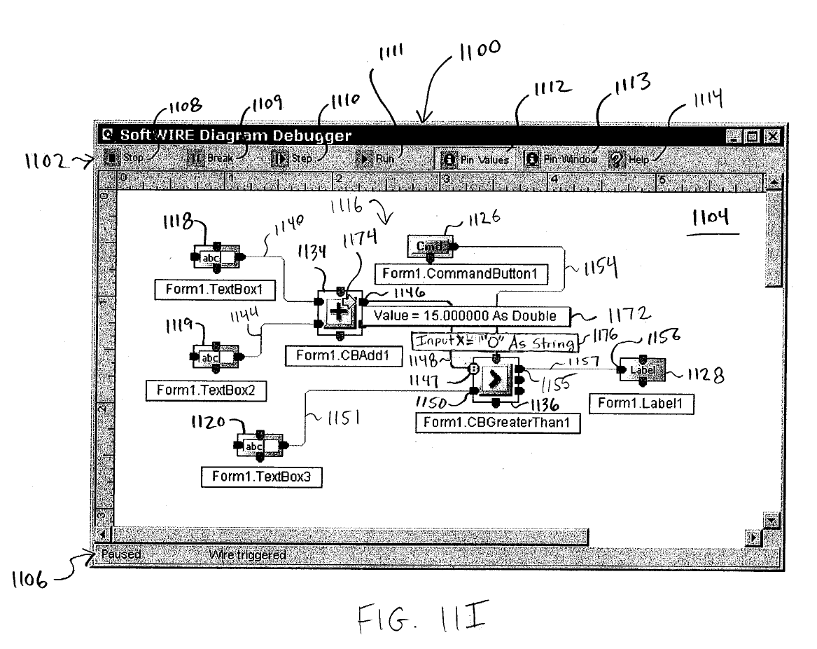

FIG. 9 is a highly schematic illustration of a GUI 900 generated by the program-development environment 310 (FIG. 3) on computer screen 235. GUI 900, which is similar to GUI 400 (FIG. 4A), includes one or more form windows 904 and a diagrammer or designer window 906. The form window 904 includes a user form program object 908, which provides an image of the user interface being developed for the application program. GUI 900 furthers include a menu bar 910 with a plurality of pull-down menu items, including a Run pull-down menu item 910a, among others, and a toolbar 912 that contains a plurality of buttons providing short-cuts to commonly used tasks or functions. The designer window 906 also includes its own toolbar 914, which may be divided into a plurality of sub-toolbars, such as sub-toolbars 914a-j, each having a corresponding tab that may be labeled (e.g., Function, Array, Business, Control, Database, Database (DB) Advanced, Excel, GPIB Control, GUI, and Home Automation). Disposed on each sub-toolbar 914a-j are one or more pictorial representations. Each pictorial representation corresponds to a control or program object class, and selection of a pictorial representation (e.g., through a right mouse click) causes an instantiation of the control or program object to be placed in a form, and further causes an icon to appear in at least the designer window 906. Included on the Function sub-toolbar 914a is an Enable Debugging button 916 as well as several pictorial representations of controls.

Those skilled in the art will recognize that other tabs may be provided depending on the control classes that are being provided by the graphical designer system 314.

Suppose the program developer wants to create a program that generates a sum by adding two numbers together, and then compares the sum to a third number to see whether the sum is greater than the third number. To create such an application program, the developer may select a text box pictorial representation (not shown) residing on the GUI tab 914i three times. In response, the program-development environment 310 instantiates three text box program objects from the previously defined text box class, and adds those objects to the container application represented by form window 904. Environment 310 also causes three text box icons 918-920 to appear in the diagrammer window 906, and causes three text box user interface elements 922-924 to appear in the form window 904. User interface elements 922-924 basically correspond to the way in which the text boxes will appear in the user interface during application run-time. Each of the user interface elements 922-924 as well as icons 918-920 may be moved and/or re-sized by the developer in a conventional manner.

The developer may also select a command button pictorial representation (not shown) and a label pictorial representation (not shown) also residing on the GUI tab 914i. In response, environment 310 instantiates a command button program object or control from the command button class, a label control from the label class and adds these controls to the container application. Environment 310 also causes a command button icon 926 and a label icon 928 to appear in the diagrammer window 908. Environment 310 further causes a command button user interface element 930 and a label user interface element 932 to appear in the form window 904. From a Math tab (not shown), the developer preferably selects an “add” pictorial representation and a “greater than” pictorial representation. In response, environment 310 instantiates an add control from the add class and a greater than control from the greater than class. Environment 310 further causes an add icon 934 and a greater than icon 936 to appear in the diagrammer window 906. Because the add and greater than controls are not manipulated by the program user during run-time, no corresponding user interface elements or symbols are added to the form window 904 for these controls.

As described above, each of the icons within the diagrammer window 906 have one or more pins or terminals so that the icons can be graphically linked together to form a block diagram 917 that represents the logical operation of the application program being developed. In particular, first text box icon 918 has a data output pin 938, which is associated with that control's Text property, that may be visually connected to a first data input pin 939 of the add icon 934 by a first wire construct 940. The first data input pin 939 of the add icon 934 is associated with its “X Input” property. Second text box icon 919 may similarly have a data output pin 942 that is visually connected to a second data input pin 943 of the add icon 934 by a second wire construct 944. The add icon's second data input pin 943 is associated with its “Y Input” property. The add icon's data output pin 946, which is associated with its Value property, is coupled to a first data input pin 947 of greater than icon 936 by a third wire construct 948, and the third text box icon's data output pin 949 is coupled to a second data input pin 950 of greater than icon 936 by a fourth wire construct 951. The first and second data input pins 947 and 950 of greater than icon 936 are associated with its “Input X” and “Input Y” properties. Command button icon 926 may have a data output pin 952 coupled to a control in pin 953 of greater than icon 936 by a fifth wire construct 954, and the greater than icon 936 may have a first data output pin 955 coupled to a data input pin 956 of label icon 928 by a sixth wire construct 957. The greater than icon's first data output pin 955 is associated with its “Greater Than” property, which outputs true only if the control's “X Input” property is greater than its “Y Input” property.

Next, suppose that the developer wants to debug this application program to ensure that it operates as expected. To run the program in debug mode, the developer preferably activates the debugger utility 315, and runs the application program. In the illustrative embodiment, the enable debugging button 916 on the Function sub-tool bar 914a may be toggled between an “on” position and an “off” position by the program developer. For example, the developer may toggle the enable debugging button 916 by selecting, e.g., clicking, it with a mouse. The look of button 916 may change from a high-lighted appearance, when it is on, to a non-highlighted appearance, when it is off. To have the program run in the debug mode, the developer selects the enable debugging button 916 so that it is highlighted, thereby activating the debugger utility 315, and causing the application program, when run, to be run in debug mode.

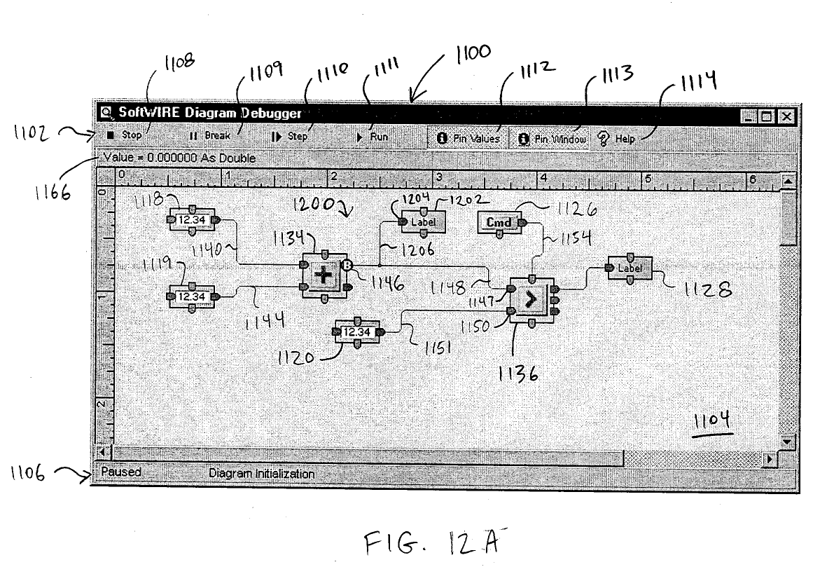

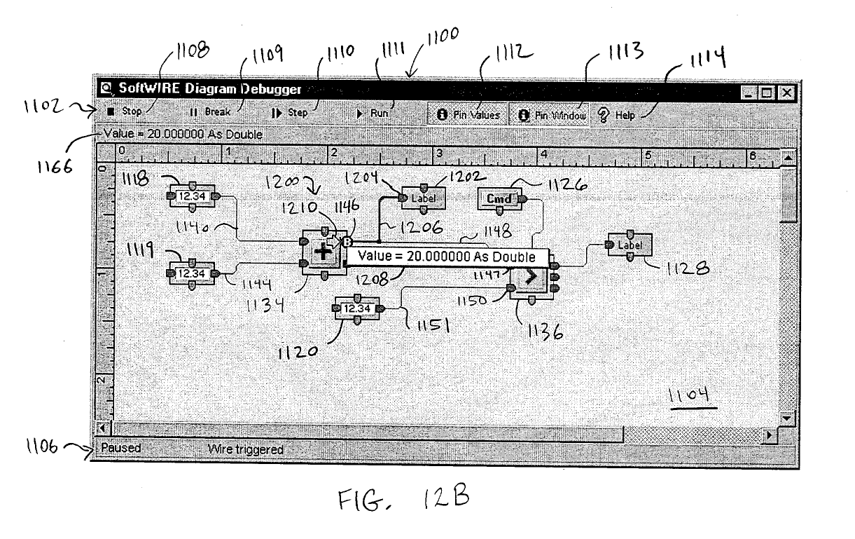

With the debugger utility 315 activated, and the program-development environment 310 ready to execute in debug mode, the developer next runs the application program. To run a program, the developer preferably selects the Run pull-down menu item 910a, which causes a dialog window 958 (FIG. 10) to appear on the screen 235. Dialog window 958 includes a plurality of command buttons associated with the run operation, including a start button 959, among others. From dialog window 958, the developer is preferably selects the start button 959.

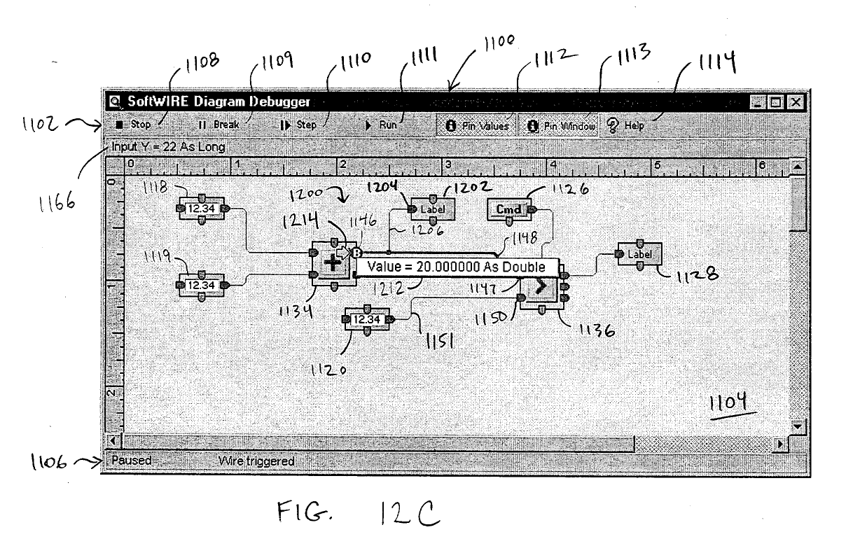

With the debugger utility 315 activated, and the program-development environment 310 ready to operate in debug mode, selection of the start button 959 causes the debugger utility 315 to generate and display a debugger window to the developer. FIGS. 11A-I are highly schematic illustrations of a preferred debugger window 1100. As described herein, the debugger window 1100 displays information regarding the state of the application program as it is executed. In the illustrative embodiment, the debugger window 1100 uses the same block diagram that was used to define the application to represent the program's execution in debug mode. In a preferred embodiment, the debugger utility 315 only operates when the application is run inside the program-development environment 310, e.g., from within Visual Basic or Visual Studio.

The debugger window 1100 preferably includes a number of components, including a toolbar 1102, a debug area 1104 and a status bar 1106. The toolbar 1102 displays a plurality of tools that are available to the developer to control the debugging process. Exemplary tools include stop 1108, break 1109, step 1110, run 1111, pin values 1112, pin window 1113 and help 1114, each of which may be selected by the developer during debugging. Selection of the stop tool 1108 terminates the debugging session, closes the debugger window 1100 and returns the developer to program design mode, e.g., to GUI 900 (FIG. 9). Selection of the break tool 1109 causes the debugger utility 315 to pause program execution at the next event following the developer's selection of the break tool 1109. Selection of the step tool 1110 causes the debugger utility 315 to permit the next wire construct or icon in the program sequence to be triggered before execution is again paused. By repeatedly selecting the step tool 1110, the developer can step through execution of the application program one block or wire construct at a time, as described in greater detail below. Selection of the run tool 1111 causes the debugger utility 315 to run the application program at normal speed until it completes, until the program reaches a break point, or until the program is paused or stopped by the developer. Selection of the pin values tool 1112 causes a popup window to appear proximate to a pin identified by the developer. The popup window contains the name, value and format of the property associated with a pin identified by the developer. Selection of the pin window tool 1113 causes a floating window to appear that displays the name, value and format of the property associated with the identified pin. The floating window can be resized and moved to any desired location. In the illustrative embodiment, the developer identifies a pin for display in the popup or floating window by using the mouse to “hold” the cursor over the selected pin. Selection of the help tool 1114 causes a help dialog box to appear on the screen.

The status bar 1106 displays information regarding the current state of the application program that is being run in debug mode. If the program is running, the debugger utility 315 causes the term “Running” to appear in the status bar 1106. If the program has paused, the debug utility 315 preferably causes the term “Paused” to be displayed in the status bar 1106. Other information, which is largely self-explanatory, such as “Diagram Initialized”, may be included within the status bar 1106 by the debugger utility 315.

Within debug area 1104 is a block diagram 1116, which is preferably the same as the block diagram 917 (FIG. 9) that was formed in the diagrammer window 906 during program design time. In particular, block diagram 1116 includes the same icons, pins and wires that were added to and used in graphically defining the block diagram 917. The pins, wires and icons of block diagram 1116 have been given the same reference numerals as in FIG. 9, except that the “9” prefix has been replaced with an “11” prefix. Nevertheless, unlike block diagram 917, which can be modified by the developer, block diagram 1119 cannot be changed. That is, the developer cannot add, delete, or move icons or wire constructs within debugger window 1100. If the developer needs to make changes to the block diagram 1116, the developer must exit from debug mode and return to program design mode by selecting the stop tool 1108.

In the illustrative embodiment, the debugger utility 315 in cooperation with the program-development environment 310 initializes the application program for execution, but pauses execution before loading any user interface forms, such as form 904 (FIG. 9). Specifically, the debugger utility 315 pauses execution of the application program at the start of the Wire1.Initialize( ) function, which is the process used to initialize the first wire construct that forms part of the application program. Furthermore, to prevent abnormal behavior of the application program during debugging, such as the generation of spurious or erroneous results, the debugger utility 315 preferably disables all of the application's forms, namely, the application form, the property browser and the toolbox. This is preferably done by setting the other forms Enabled property to false. The debugger utility 315 also imposes an Always_On_Top command to the debugger window 1100 to force window 1100 to remain on top of, e.g., in front of, any other windows that might be opened, or that might open during debugging, even if the debugger window 1100 is not the active window.

Before running the application program in debug mode (or while the application program is running), the developer can insert one or more break points at selected locations in the program. In particular, the debugger utility 315 includes a break point insertion tool that can be used by the developer to graphically specify one or more break points. As described herein, the break point insertion tool of the present invention allows the developer to insert a break on one or more pins, wires or blocks of the block diagram 1116.

Setting Break Points on Blocks

Suppose that the developer wishes to determine whether the greater than comparison function is receiving and generating the correct values. In this case, the developer places a break point on greater than icon 1136. To insert the break point, the developer preferably utilizes the break insertion tool. Specifically, the developer, using the mouse, selects, e.g., double-clicks, the chosen block, i.e., greater than icon 1136. In response, the debugger utility 315 imposes a break point in the application program after the identified block has fired or raised its RunBlock event, executed its function and updated its properties, but before the block has fired or raised either its DataReady or Control Out events, i.e., the break is inserted between steps 712 and 714 (FIG. 7). In other words, the program will be paused after the identified block performs its function, in this case comparing the two inputs, and after updating its properties, but before those properties are passed to any other control or wire construct of the application program. The break point also occurs after execution of any event handlers that were textually defined for this block in response to its RunBlock event. Textually defined event handlers that are responsive to subsequent events, such as the control's DataReady and ControlOut events, are not yet executed. To aid in debugging, the debugger utility 315 also provides a visual cue to the developer that a break point has been inserted on the identified block. In the illustrative embodiment, the debugger utility 315 replaces the block's thin gray outline or border with a thick red outline or border 1160 (FIG. 11A).

For blocks configured to issue PreRunBlock and PostRunBlock events, rather than a single RunBlock event, a break point inserted on a block may be configured to pause execution before issuance of the PreRunBlock event. Alternatively, execution may be paused after the block raises its PreRunBlock event, but before raising its PostRunBlock event. In yet another embodiment, execution may be paused after the block raises its PostRunBlock event.

After placing the break at the greater than icon 1136, the developer preferably runs the application program in debug mode. To begin running the program in debug mode, the developer preferably selects the run tool 1111. In response, the debugger utility 315 in cooperation with the program-development environment 310 loads and displays the user interface form(s), if any. Nonetheless, the debugger window 1100 remains on top because the Always_On_Top command that was asserted by the debugger utility 315. The program commences execution in sequential order from its starting point, which may be the first text box control corresponding to text box icon 1118. For example, the values associated with the Text properties of the controls corresponding to the first and second text box icons 1118 and 1119, e.g., “10” and “5”, are passed to the add control represented by icon 1134 by wire constructs 1140 and 1144, and the two values added together to generate a sum, e.g., “20”. The add control's Value property is set to this sum, and the control fires its DataReady event. The add control's Value property is then retrieved by wire construct 1148 and passed to the control represented by greater than icon 1136. In particular, the value of the greater than control's “Input X” property is set to equal the value of the sum. The value associated with the Text property of the control corresponding to the third text box icon, e.g., “9”, is similarly retrieved by wire construct 1151 and passed to the greater than control. Specifically, the value of the greater than control's “Input Y” property is set to equal the third text box control's Text property. Next, the control represented by command button icon 1126 causes the greater than icon's ControlIn property to be updated, e.g., set to True.

In order for the program object corresponding to the command button icon 1126 to update the ControlIn property of the program object corresponding to the greater than icon 1136, the developer must “press”, e.g., select with the mouse, the user interface element corresponding to the command button icon 1126 from the user interface form (not shown), which the debugger utility 315 causes to be generated and displayed on screen 235. In other words, selecting the Run tool 1111 causes those program objects whose ControlIn pins have not been wired or connected to execute in program order until a break point is reached or until a program object whose ControlIn pin has been wired (and not yet updated) is reached.

As each control performs its function, the debugger utility 315 preferably changes the appearance of the icon representing that control to provide the developer with a visual indication of the progress of the program's execution. Similarly, as each wire construct executes by getting the value associated with its source object and setting the value associated with its sink object, the debugger utility 315 changes the visual appearance of the wire construct. In the illustrative embodiment, as each control executes, the debugger utility 315 replaces the thin gray outline or border that surrounds the control's icon with a thick or heavy outline or border that is preferably green in color. When the block completes its execution, the debugger utility 315 returns its outline or border back to its original thin gray appearance. When a wire executes, its thin gray line is replaced with a thick green line. Similarly, once the wire completes its execution its appearance is returned back to a thin gray line. Because these changes happen at run-time speed, the modification of a block or wire from faint gray to heavy green and back to faint gray may simply appear to the developer as a fast flicker through the blocks and wires of the block diagram. That is, it may be difficult, if not impossible, for the developer to actually see the blocks and wires change appearance.

Those skilled in the art will recognize that other visual and/or audible cues may be employed by the debugger utility 315 other than or in addition to those described above. For example, other colors may be used, the background of icons may be changed, shadows may be temporarily added, etc.

At this point, the greater than control of icon 1136 has received its two inputs and its ControlIn property has been updated. Accordingly, the greater than control is now ready to perform its function, namely comparing the values of its “Input X” and “Input Y” properties. The greater than control fires or raises its RunBlock event, performs its respective function and updates its properties, i.e., its Greater Than and Value properties.

However, before the control can fire its DataReady event (or its RateReady or StatusReady events as the case may be) and its ControlOut event, the debugger utility 315 pauses the execution of the program in response to the break point that was graphically inserted by the developer at the greater than icon 1136.

The debugger utility 315 preferably utilizes one or more visual cues to notify the developer where execution has paused due to the inserted break point. In the illustrative embodiment, the debugger utility 315 draws a second border or outline 1162 (FIG. 11B) around the greater than icon 1136. This second border or outline 1162 is preferably outside of the thick red border 1160 that was added when the break point insertion tool was used to place a break point at the greater than icon 1136. The second border 1162, moreover, is preferably drawn with a thick green line. The fact that the program has been paused is also reflected in the status bar 1106, which has been updated by the debugger utility 315 by replacing the term “Running” with the term “Paused”. The status bar 1106 further includes the information “Block triggered” to indicate that the program was paused while a block was being triggered.

Again, those skilled in the art will recognize that other visual cues may be used to indicate where execution has been paused.

With the application program paused, the developer can check the values associated with various pins by positioning the cursor over those pins, provided that the pin values or the pin window tools 1112 and 1113 have been activated. Specifically, by “holding” the cursor over a pin, the developer can “see” the value associated with that pin, as determined at this point in the execution of the application program. For example, suppose that the pin values tool 1112 is active, and the developer uses the mouse to hold the cursor over the greater than icon's first data input pin 1147. In response, the debugger utility 315 detects the presence of the cursor over a pin, and retrieves the name, current value and format of the property associated with that pin, e.g., “Input X, 20, Double”. The debugger utility 315 then generates a popup window 1164 (FIG. 11C) that contains the name, e.g., “Input X”, the value, e.g., “20”, and the format, e.g., “Double”, of the property associated with the selected pin, i.e., pin 1147. The popup window 1164 is displayed on screen 235 preferably near the selected pin, i.e., proximate to pin 1147. When the developer moves the cursor off of pin 1147, the debugger utility 315 detects this change and, in response, causes the popup window 1164 to disappear from screen 235. Each time the developer holds the cursor over a pin, the debugger utility 315 retrieves the name, value and format of the property associated with that pin, and displays that information within a popup window. In this way, the developer can examine the state of the application program, which has been paused at the greater than control of icon 1136.

Suppose that, instead of selecting the pin values tool 1112, the developer selects the pin window tool 1113. Suppose further that the developer then uses the mouse to hold the cursor over the second data input pin 1150 of the greater than icon 1136. In response, the debugger utility 315 detects the position of the cursor over a pin within block diagram 1116. The debugger utility 315 responds by generating a floating pin window 1166 (FIG. 11D) that contains the name, e.g., “Input Y”, the value, e.g., “22”, and the format, e.g., “Long”, of the property associated with the selected pin, i.e., pin 1150. The developer can re-size and move floating pin window 1166 about the screen 235 by dragging it with the mouse. The floating pin window 1166 can also be docked just below toolbar 1102 or just above status bar 1106. In the illustrative embodiment, unlike the pop up window 1164, the floating pin window 1116 does not disappear when the developer moves the cursor away from the current pin. Instead, the floating window remains and continues to display the name, value and format of the property associated with the lasts pin over which the cursor was held. If the cursor is subsequently held over a new pin, the debugger utility 315 retrieves the name, value and format of the property associated with this new pin, and displays this new information in the floating window 1166, replacing the previous information.

In addition, the floating pin window 1166 can be used to watch a pin's value change over time as the application program executes in debug mode. Specifically, as described above, when the developer holds the cursor over a pin, the debugger utility 315 retrieves the name, current value and format of the property associated with that pin, and displays that information in the floating pin window, even if the developer then moves the cursor away from the pin. The debugger utility 315 periodically (e.g., several times a second) polls the value associated with the pin, and displays the polled value in the floating pin window 1166. Thus, as the pin's value changes, the changes are displayed in the floating pin window 1166. To conserve processing resources, the polling of a pin's value is only performed when the pin window tool 1113 is active.

The developer may also activate both the pin values tool 1112 and the pin window tool 1113 simultaneously. In this case, when the developer holds the cursor over a pin,. e.g., second data input pin 1150 of the greater than icon 1136, popup window 1164 (FIG. 11E) appears as described above. In addition, the floating window 1166, which in FIG. 11E has been docked just below the tool bar 1102, also displays the name, value and format of the property associated with the selected pin, i.e., pin 1150.

To resume operation of the application program, the developer preferably selects the run tool 1111. In response, the debugger utility 315 continues executing the application program. Specifically, the greater than control of icon 1136 fires or raises its DataReady event. In response to the greater than icon's DataReady event, wire construct 1157 retrieves the current value, e.g., True, of the greater than control's “Greater Than” property and uses this value to set the Caption property of the label icon 1128. The label control of icon 1128, in turn, causes this value to be displayed in its corresponding user interface element. Execution of the application is now complete.

With execution complete, the developer can again go back and evaluate the values associated with the pins of block diagram 1116. Specifically, the developer can activate the pin values and/or the pin window tools 1112 and 1113, and use the mouse to hold the cursor over selected pins.

Setting Break Points on Wire Constructs

In addition to setting break points on blocks or icons, the developer can also set break points on wire constructs. Suppose the developer wishes to set a break point on the wire construct 1148 that links the data output pin 1146 of the add icon 1134 to the first data input pin of the greater than icon 1136. To set a break point on a wire construct, the developer preferably selects, e.g., double-clicks with the mouse, the desired wire construct 1148. In response, the debugger utility 315 inserts a break point into the application program. In the preferred embodiment, the break point is placed at the point where the selected wire is triggered by its source block, in this case after add icon 1134 fires its DataReady event, after the wire construct has received the source property and updated its Value property, but before the wire construct raises any of its events. That is, the break point is placed after step 612 (FIG. 6A) but before step 614. The debugger utility 315 also changes the appearance of the selected wire construct to indicate that a break point has been placed on the wire. For example, the debugger utility 315 may change the wire's appearance from a thin gray line to a thick red line, as illustrated in FIG. 11F.

To run the application program in debug mode, the developer selects the run tool 1111. The application proceeds by passing the values from the controls corresponding to the first two text box icons 1118 and 1119 to the control of the add icon 1134 where the two values are added together to generate a sum. The add control then sets its Value property equal to the generated sum, and fires or raises its DataReady event. This would typically cause wire construct 1148, which is coupled to the add icon's data output pin 1146, to get the value associated with this pin, i.e., the sum generated by the add control, and use it to set the property associated with the data input pin 1147 of the greater than icon 1136, which is associated with the greater than control's “Input X” property. In this case, however, a break point was inserted at wire construct 1148, causing the program's execution to be paused at this point. More specifically, execution is paused after the source object, i.e., the add control of icon 1134, fires its DataReady event, but before wire construct 1148 has retrieved the source property value.

The debugger utility 315 preferably indicates that execution has reached the break point set on wire construct 1148 by using one or more visual cues. For example, the debugger utility 315 may change the appearance of wire construct 1148 from a thick red line (which was used to indicate that a break point had been set on the wire construct) to a thick green line to indicate that the wire construct is about to run. In addition, the name, value and format of the property associated with the wire construct's source pin, i.e., data output pin 1146 of add icon 1134, is automatically displayed in a popup window 1168 (FIG. 11G). Debugger utility 315 also displays an arrow 1170 that points to the source pin 1146 for which the popup window 1168 was generated. Arrow 1170 helps the developer identify the pin to which the information in popup window 1168 refers.

It should be understood that popup window 1168 and arrow 1170 appear regardless of the position of the cursor. That is, popup window 1168 and arrow 1170 appear even though the cursor may not be on or even near pin 1146.

To resume execution of the application program from this break point, the developer preferably selects the run tool 1111. In response, debugger utility 315 resumes program execution. Specifically, the wire construct 1148 retrieves the value associated with its source pin 1146, and copies this value to its sink pin 1147. The debugger utility 315 also causes both popup window 1168 and arrow 1170 to disappear. Furthermore, the debugger utility 315 returns the wire construct 1148 back to its original appearance, e.g., back to a thick red line.

Setting Break Points on Pins

In accordance with the present invention, the debugger utility 315 further supports the insertion of break points on pins, including data input pins, data output pins, ControlIn pins and ControlOut pins. As described herein, a breakpoint inserted on a pin causes the debugger utility 315 to insert a break point on each wire construct connected to that pin. In other words, program execution is paused as each wire construct connected to the pin having the break point is triggered. For a data output pin or a ControlOut pin, this means that the property associated with the pin will have its new value by the time the break point is reached, but the wire construct will not have passed that new value to the wire construct's sink property. For a data input pin or a ControlIn pin, this means that the pin will still contain its old value when the break point is reached.

Suppose, for example, that the developer wishes to insert a break point on the first data input pin 1147 of the greater than icon 1136. To activate the break point insertion tool on a pin, the developer selects pin 1147 with the mouse, i.e., the developer double-clicks the pin. The debugger utility 315 responds by inserting a break in the application program at the respective point. More specifically, for a break on data input pin 1147, the debugger utility 315 imposes a break just before wire construct 1148, raises its Action event, i.e. after step 612 (FIG. 6A) but before step 614. Thus, the break point is inserted before wire construct 1148, which is the wire construct connected to pin 1147, sets the property associated with pin 1147, i.e., just before setting the greater than control's “Input X” property. The debugger utility 315 also changes the appearance of pin 1147 in block diagram 1116 to indicate that a break point has been set on the pin. For example, the debugger utility 315 may change the pin from its normal, light gray “bullet” shape, to a red-colored octagon with the letter “B” inside, as shown on FIG. 11H.

After setting the break point on pin 1147, the developer preferably runs the application program in debug mode. As described above, to begin running the program in debug mode, the developer preferably selects the run tool 1111, which causes the debugger utility 315 to run the application program. For example, the values associated with the first and second text box controls of icons 1118 and 1119, e.g., “10” and “5”, are passed to the add control of icon 1134 by wire constructs 1140 and 1144. These two values are then added together to generate a sum, e.g., “20”, and the add control sets its Value property to this sum. The add control then fires its DataReady event. In response to the add control's DataReady event, wire construct 1148 gets the value associated with data output pin 1146, and updates its Value property. Before wire construct 1148 can raise its Action event, however, the break point set on pin 1147 is reached, causing the debugger utility 315 to pause execution.

The debugger utility 315 preferably utilizes one or more visual cues to notify the developer where execution has paused due to the inserted break point. In particular, as described above in connection with a break point set on wire construct 1148, the debugger utility 315 preferably causes a popup window 1172 (FIG. 11I) to be generated and displayed on screen 235. Popup window 1172 contains the name, value and format of the property associated with data output pin 1146, i.e., with the add control's Value property. Debugger utility 315 also causes an arrow 1174 pointing to data output pin 1146 to be generated and displayed so that the developer will understand that the information contained in popup window 1172 corresponds to this pin 1146. In addition, the debugger utility 315 preferably changes the appearance of wire construct 1148, e.g., from a faint gray line to a thick green line, signaling that execution has paused at wire construct 1148.

As described above, the developer may activate the pin values tool 1112 and hold the cursor over a pin to reveal the name, value and format of the property associated with that pin. Suppose, for example, that the developer holds the cursor over the first data input pin 1147 of the greater than icon 1136, which is the pin on which the break point was inserted. In response, the debugger utility 315 causes a popup window 1176 to be generated and displayed preferably in proximity to pin 1147. This popup window 1176 contains the name, value and format of the property associated with pin 1147, i.e., with the “Input X” property of the greater than control. Because of the break point inserted at pin 1147, execution of the application program was paused before the sum generated by add icon 1134 is passed to the greater than icon's first data input pin 1147. Accordingly, as reflected in popup window 1172, pin 1147 is still set to its default value, i.e., to “0”.

In a similar manner, the developer can move the cursor over other pins of the block diagram 1116 to examine the values currently associated with those pins.

To resume execution of the program, the developer selects the run tool 1111. The debugger utility 315 responds by resuming execution of the application program. Specifically, the sum generated by the add control is retrieved by wire construct 1148, and passed to the first data input pin 1147 of the greater than icon 1136. Next, the Value property of the third text box control of icon 1120 is passed to the second data input pin 1150 of the greater than icon 1136. The two values are then compared and, if the value received on the first data input pin 1147 is greater than the value received on the second data input pin 1150, the greater than control sets its Value property to True. Next, selection of the command button user interface element by the developer causes the ControlIn property of the greater than control to be updated, thereby allowing the greater than control to fire its DataReady event. In response to the greater than control's DataReady event, the value associated with its first data output pin, e.g., “True”, is passed to the label control of icon 1128 by wire construct 1157. Execution of the application is now complete.

Break points may also be set on data output pins. FIG. 12A is a highly schematic illustration of a debugger window 1100 that is similar to the debugger window illustrated in FIGS. 11A-I. Debugger window 1100 includes a block diagram 1200 that is similar to block diagram 1116, except that it includes an additional label icon 1202 whose data input pin 1204 is connected to data output pin 1146 of add icon 1134 by a new wire construct 1206. In other words, two wire constructs 1148 and 1206 are connected to data output pin 1146. In addition, the developer has inserted a break point at pin 1146 as indicated by the red octagon with the letter “B” in place of the pin's original appearance.

When this application is run, execution proceeds until the add control updates its Value property with the generated sum, and fires its DataReady event. At this point, execution is paused in response to the break point inserted at pin 1146. More specifically, execution is paused just before wire construct 1206, which is connected to label icon 1202, raises its Action event. The debugger utility 315 preferably causes a popup window 1208 (FIG. 12B) to be generated and displayed on screen 235. Popup window 1208 contains the name, value and format of the property associated with data output pin 1146, i.e., the add control's Value property. Debugger utility 315 also causes an arrow 1210 pointing to data output pin 1146 to be generated and displayed so that the developer will understand that the information contained in popup window 1208 corresponds to this pin 1146. In addition, the debugger utility 315 preferably changes the appearance of wire construct 1206, which is the point at which execution was paused. Specifically, the appearance of wire construct 1206 is changed from a faint gray line to a thick green line, signaling that execution has been paused at wire construct 1206.

To continue execution of the program, the developer selects the run tool 1111. In response, wire construct 1206 retrieves the value associated with data output pin 1146 and passes it to the label control of icon 1202. The debugger utility 315 then returns wire construct 1206 back to its original appearance, e.g., from a thick green line back to a thin gray line. The next operation would be for wire construct 1148 to retrieve the value associated with data output pin 1146 and pass it to data input pin 1147 of the greater than icon 1136. However, execution of the application program is again paused before wire construct 1148 raises its Action event due to the insertion of the break point at data output pin 1146. That is, the insertion of the single break point at data output pin 1146 causes execution of the program to be paused twice; once just before wire construct 1206 runs, and again just before wire construct 1148 runs.

Again, debugger utility 315 preferably causes a popup window 1212 (FIG. 12C) to be generated and displayed on screen 235. Popup window 1212 contains the name, value and format of the property associated with data output pin 1146, i.e., add control's Value property. Debugger utility 315 also causes an arrow 1214 pointing to data output pin 1146 to be generated and displayed so that the developer will understand that the information contained in popup window 1212 corresponds to this pin 1146. In addition, the debugger utility 315 preferably changes the appearance of wire construct 1148, which is the point at which execution was paused for the second time. Specifically, the appearance of wire construct 1148 is changed from a faint gray line to a thick green line, signaling that, this time, execution has paused at wire construct 1148.

To continue execution of the program, the developer once again selects the run tool 1111. In response, wire construct 1148 fires its Action event and passes the value associated with data output pin 1146 to the greater than control of icon 1136. The debugger utility 315 then returns wire construct 1148 back to its original appearance, e.g., from a thick green line back to a thin gray line. Program execution then continues until completion.

It should be understood that, if a break point is inserted at a data input pin to which two or more wire constructs are connected, that the execution of the program will be paused once for each such wire construct.

Step-wise Debugging

By repeatedly selecting the step tool 1110, the developer can single-step through execution of the application program. In this mode, the debugger utility 315 will pause execution every time a block or wire construct is triggered. Accordingly, the developer can use this mode to examine the order in which the application program will be run, block-by-block and wire-by-wire. The single-step debug mode may be overridden at any time by selecting the run tool 1111 or the stop tool 1108. By single-stepping through the application program, the developer can also “see” each block and wire construct change from its original appearance to its executing appearance (e.g., from light gray to heavy green) and back to its original appearance. As described above, these changes may not be visible to the developer when the application program is executed at run-speed.

It should be understood that one or more of the tools 1108-1114 may alternatively be selected or activated through keyboard inputs, rather than selecting the tools with a mouse. In addition, break points may be inserted by right-clicking a pin, wire or block, which causes the debugger utility 315 to generate and display a command window (not shown) from which the developer can select a “Toggle Breakpoint” command. Selection of the “Toggle Breakpoint” command inserts a break point just as if the pin, wire or block had been double-clicked as described above.

It should be further understood that the debugger utility 315 allows the developer to set or clear breakpoints while the application program is being run in debug mode. Similarly, the developer can examine the values associated with pins while the application program is being run in debug mode using the pin values 1112 and/or pin window 1113 tools described above.

In the illustrative embodiment, the setting of break points within the debug area 1104 is preferably saved by the debugger utility 315, e.g., within the program's project file, for use during the next debug session.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for debugging a two-dimensional (2-D) block diagram representing an application program, the block diagram having a plurality of icons, each representing a respective function, and a plurality of wire constructs, each icon having one or more pins and each wire construct interconnecting respective pins of at least two icons, each pin associated with a property having a value, the method comprising the steps of:
receiving a request to execute the application program in a debug mode;
generating a debugger window containing the 2-D block diagram;
inserting a break point into the application program in response to receiving a graphical input identifying a selected pin of the 2-D block diagram, wherein at least one wire construct is connected to the selected pin at which the break point is inserted;
commencing execution of the application program in accordance with a program execution sequence;
pausing execution of the application program upon reaching the at least one wire construct connected to the selected pin at which the break point is inserted; and
in response to receiving a graphical input identifying a given pin of the 2-D block diagram, displaying a current value of the property associated with the given pin.

2. The method of claim 1 further comprising the steps of inserting a break point into the application program in response to receiving a graphical input identifying a selected icon of the 2-D block diagram.

3. The method of claim 2 further comprising the step of inserting a break point into the application program in response to receiving a graphical input identifying a selected wire construct of the 2-D block diagram.

4. The method of claim 1 wherein each icon and wire construct of the 2-D block diagram has an original appearance, the method further comprising the steps of:
as each icon and wire construct is executed, altering the appearance of the respective icon and wire construct from its original appearance to an executing appearance; and
after each icon and wire construct is executed, returning the appearance of the respecitve icon and wire construct back to its original appearance.
